(19) United States
(12) Patent Application Publication
(10) Pub. No.: US 2019/0325463 A1
(43) Pub. Date: Oct. 24, 2019

(54) SYSTEMS AND METHODS FOR PRODUCT-LINE PRICING UNDER DISCRETE MIXED MULTINOMIAL LOGIT DEMAND

(71) Applicants: Hongmin Li, Tempe, AZ (US); Scott Webster, Tempe, AZ (US)

(72) Inventors: Hongmin Li, Tempe, AZ (US); Scott Webster, Tempe, AZ (US)

(73) Assignee: Arizona Board of Regents on behalf of Arizona State University, Tempe, AZ (US)

(21) Appl. No.: 16/393,620

(22) Filed: Apr. 24, 2019

Related U.S. Application Data
(60) Provisional application No. 62/662,045, filed on Apr. 24, 2018.

(51) Int. Cl. G06Q 30/02; G06Q 10/06

(52) U.S. Cl. CPC G06Q 30/0202; G06Q 10/067; G06Q 30/0283

(57) ABSTRACT

Embodiments of a pricing solution system for product line pricing under discrete mixed multinomial logit demand are disclosed.

### CROSS REFERENCE TO RELATED APPLICATIONS

This is a U.S. non-provisional patent application that claims benefit to U.S. provisional patent application Ser. No. 62/662,045 filed on Apr. 24, 2018, which is incorporated by reference in its entirety.

### FIELD

The present disclosure generally relates to extrinsic pricing solutions, and in particular to systems and methods for product-line pricing under discrete mixed multinomial logit demand.

### BACKGROUND

Increasingly diversified market preferences have driven firms to offer multiple substitutable products that differ in various dimensions such as features and prices. The resulting product proliferation increases the complexity of many business decisions, one of which is pricing. In practice, two major hurdles exist in pricing: (1) the frequent updating of the product line as a firm introduces new products and retires old products (i.e., product prices need to be adjusted each time such an event occurs); (2) the heterogeneity in the customer population (i.e., different types of customers use the products differently and consequently value them differently). As such, a decision tool is in order to systematically optimize prices, accounting for past sales and price information and adjusting to changes in the product line as well as heterogeneity in the customer population.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is a graphical representation showing profit by market share, according to aspects of the present disclosure;

FIG. 2A is a graphical representation showing concave profit and FIG. 2B is a graphical representation showing non-concave profit, according to aspects of the present disclosure;

FIG. 3 is a graphical representation showing the efficient frontier of profit vs. total market share, according to aspects of the present disclosure;

FIG. 4 is a graphical representation showing the sales distribution among products, according to aspects of the present disclosure;

FIG. 5 is a graphical representation showing the profit distribution among customer segments, according to aspects of the present disclosure;

FIGS. 6A and 6B are graphical representations showing the efficient frontier solution, according to one aspect of the present disclosure;

FIG. 7 is a simplified network/system diagram illustrating a computing network configured to employ a pricing solution system, according to aspects of the present disclosure;

FIG. 8 is a flowchart illustrating an exemplary application of a Multinomial Logit choice Model, according to aspects of the present disclosure.

FIG. 9 is a flowchart illustrating an implementation of Algorithm 1 according to aspects of the present disclosure.

FIG. 10 is a flowchart illustrating an implementation of Algorithm 2 according to aspects of the present disclosure.

FIG. 11 is a flowchart illustrating an implementation of a pricing solution system, according to aspects of the present disclosure.

FIG. 12 is a simplified block diagram of a representative computing system that may employ a pricing solution system, according to aspects of the present disclosure.

Corresponding reference characters indicate corresponding elements among the view of the drawings. The headings used in the figures do not limit the scope of the claims.

### DETAILED DESCRIPTION

Aspects of the present disclosure relate to a computer-implemented system for generating an optimal price or price solution, referred to herein as a pricing solution system 101. In some embodiments, the pricing solution system 101 may generally be embodied as one or more computing devices and code incorporating the computations defined herein, including one or more optimization algorithms related to an MMNL model. The pricing solution system 101 leverages data associated with customers and sales of products, including product features, and the computations provide a technical improvement in the area of price optimization processing.

The computer microprocessor industry may be used as an example to illustrate the challenges of pricing and price optimization due to heterogeneities in customer preferences. Consider the three microprocessor stock-keeping-units (SKUs) given in Table 1. Each SKU is defined by the unique combination of feature designs including the number of cores (number of processors run in parallel), frequency (speed of each core), TDP (an index of how much electric power the processor consumes), as well as price. Consider three different customers. Customer 1 needs a microprocessor used in a data center performing web search; customer 2 needs a microprocessor for a server performing scientific simulation studies; customer 3 needs a microprocessor for a simple database server at a small enterprise.

TABLE 1
Microprocessor SKUs

| SKU | Cores | Frequency | TDP | Price |
|---|---|---|---|---|
| 1 | 8 | 2.9 | 135 | $2100 |
| 2 | 4 | 3.2 | 95 | $1400 |
| 3 | 4 | 2.2 | 60 | $550 |

Since web search is a process that can be distributed to various cores, having more cores allows many jobs to be processed simultaneously, increasing the total number of jobs finished. This makes a high number of cores more valuable to customer 1 than a high frequency. Although a high power consumption index is unfavorable, in general, it can be compensated through the necessary cooling infrastructure in the case of larger data centers. Therefore, for customer 1, SKU 1 is more likely to be most favored. In the case of customer 2, it may be that the computing workload of the simulation studies is not easy to parallelize or distribute to multiple cores. Therefore, additional cores may not be as useful as a high frequency. In this case, SKU 2 will be most valuable. For customer 3, a low-end SKU may suffice in computation. Furthermore, a low TDP will make maintenance and cooling costs low. As a result, SKU 3 may be best for customer 3. As observed in this example, different types of customers place different emphasis on features and price. This affects their SKU choices, and consequently, should influence the firm's pricing decision.

The multinomial logit (MNL) choice model is widely used for modeling demand of multiple differentiated products. It is based on random utility maximization (customers' utility for a product follows a given random distribution and each customer chooses the product that yields the highest utility) and has been empirically proven to perform well in various industries such as transportation, telephone services and coffee purchases. A key advantage of the MNL model is attributed to its flexibility in incorporating customer characteristics in addition to attributes of the choice alternatives. In other words, the choice prediction in the MNL model may depend on both the alternatives and the customer type. For example, the utility of product i for a customer of type k can be modeled as uᵢₖ=aᵢₖ−bᵢₖpᵢ+∈ᵢ where pᵢ is the price of product i, bᵢₖ signifies type k customer's price sensitivity toward product i, aᵢₖ represents price-independent attractiveness, and ∈ᵢ signifies noise. While pricing of differentiated products under the MNL and its derived models has attracted much attention from researchers, the state of art theoretical development has focused mainly on incorporating heterogeneity across the choice alternatives and very little on heterogeneity in the customer population. That is, extant pricing models under the MNL demand focus on the case for which aᵢₖ=aᵢ and bᵢₖ=bᵢ for all k and neglect heterogeneity across different types of customers, which fails to take advantage of the MNL model's capability for making customer-specific choice predictions.

In this disclosure, an initial step is taken in filling this void and addresses the pricing problem under a form of logit choice model that incorporates customer segment information and applies it to a practical setting of pricing microprocessors at Corporation A. In particular, a discrete mixed multinomial logit (MMNL) demand model was considered, which aligns with the setting of a market that can be decomposed into a finite number of market segments, each with its own set of product utility parameters reflecting the unique emphasis that this segment of customers place on the features and price. This model is referred to as the MMNL model and the MNL model without customer-specific consideration is referred to as the basic MNL model or simply the MNL model in the remainder of the present disclosure. While this disclosure refers to an example using microprocessors made by Corporation A, it should be understood that the following can apply to any number or type of product. For example, the disclosure is not limited to microprocessor products and can be applied to products such as, but not limited to, vehicles, board games, cleaning supplies, or cell phones.

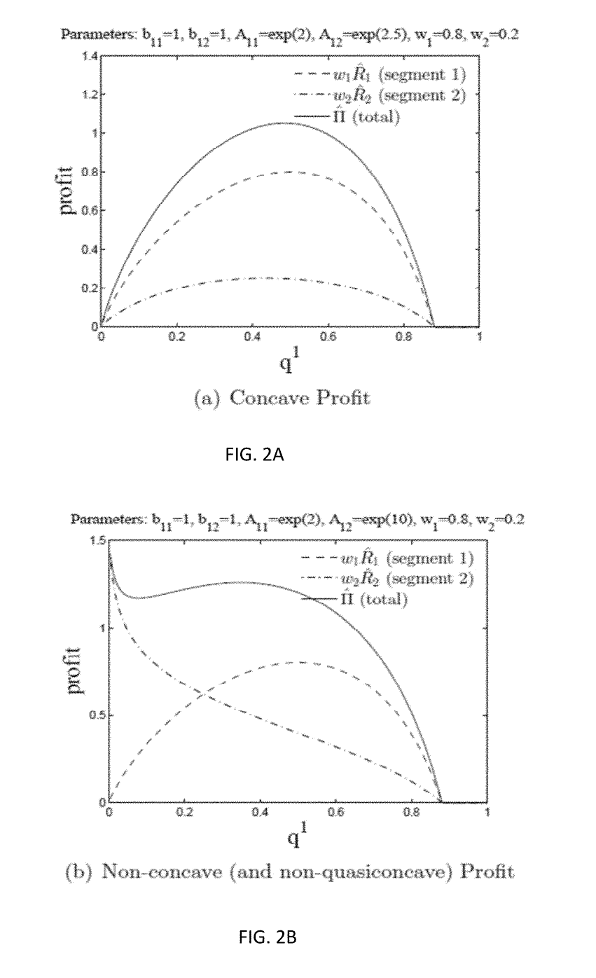

The present disclosure shows that incorporating segment-specific preference parameters breaks the concavity of the profit function with respect to the choice probability vector identified in Li and Huh (2011), as well as the analysis in Gallego and Wang (2014). The total profit is characterized as the sum of a set of quasiconcave functions with respect to a vector of market shares for a particular segment and the present disclosure shows that it is in general not a concave or quasiconcave function. The present disclosure presents an example in which the profit changes from a concave to a non-concave (and non-quasiconcave) function as the parameter values shift (see FIGS. 2A and 2B).

A salient result of profit optimization under the basic MNL model is that the optimal markups for all products are equal, which is controversial as “equal markup” for differentiated products is not commonly observed in practice. In contrast to the basic MNL model, it will be shown that the equal markup property does not hold under the MMNL model even with symmetric price sensitivities across products and segments, which helps reconcile the divergence of theoretical prediction and observed practice.

In the case that the model parameters are such that the total profit is quasiconcave (which typically occurs when the segment differences are sufficiently small), an efficient algorithm is disclosed for finding the optimal prices under the MMNL model to account for the impact of customer heterogeneity on prices. When the total profit is not quasiconcave, a gradient-descent approach is proposed to search for stationary point solutions and by randomizing the starting price vector the stationary point solution is found that is most likely to be the global optimum. In practice, management may be concerned about both profit and market share. This approach is generalized to generate the efficient frontier of optimal profit by total market share, thereby helping management to strike a balance between these two measures of interest. For example, this model may be applied to Corporation A's products, and serves to illustrate how the model can be used in practice to improve decision making and how the optimal pricing strategies derived through the analysis of the present disclosure compare with the current practice. The results show that the optimal prices exploit segment differences through redistribution of sales and profit among customer segments. In addition, the profit-market share efficient frontier is derived and the current practice relative to this frontier is located. This provides insights for decision makers on how to balance profit and market share considerations to best achieve Intel's objectives.

The contributions of the present system are both theoretical and practical. The MMNL model can approximate any discrete choice model consistent with random utility maximization (RUM) to any degree of precision. Thus, from a theoretical perspective, results regarding MMNL pricing problems reflect the character of a general discrete choice model; the solution approach being proposed for solving optimal prices under MMNL is further generalizable to other discrete choice models consistent with RUM. From a practical perspective, a systematic approach is presented for modeling demand and managing the pricing decision of a dynamically evolving product line that takes into consideration sales history and differences in the various constituents of the customer population. The decision tools derived from this research serve multiple objectives for a business entity: (1) These decision tools provide a new alternative for market share prediction among products for different customer segments, adding to the company's suite of independent demand forecasting tools; (2) these decision tools also optimize product prices based on segment-specific customer preferences revealed through sales data; (3) these decision tools quantify the tradeoff between profit and market share. Given the wide applicability of the logit family models, the analysis and the solution approach extend to a range of companies and industries, beyond Corporation A.

### Analysis of the Price Optimization Problem

The MMNL model is derived from MNL choice models with utility parameters drawn from a mixing distribution. While the MMNL model allows for a continuous mixing distribution, we limit our discussion to discrete distributions as it aligns with the setting of a market that can be decomposed into a finite number of market segments, each with its own set of product utility parameters. This discrete MMNL model is also referred to as the “latent class model” (Greene and Hensher, 2003).

While the theoretical importance of the MMNL model is clearly stated by McFadden and Train (2000) (in that it can approximate any RUM choice model with arbitrary precision), the practical importance needs emphasis. The basic MNL model embeds all market heterogeneity in the random Gumbel term, which essentially means that the known information of all customers is the same. MMNL, in contrast, explicitly models the known differences among customers, which can be more realistic and useful. In particular, consider customers making a selection of one of n product choices and a no-purchase alternative. The market is comprised of m customer segments with utility uᵢₖ=aᵢₖ−bᵢₖpᵢ+∈ᵢ for product i and segment k. The product purchase probabilities within each segment are given by the MNL model:

$${q}_{ik} = \frac{{e}^{{a}_{ik} - {b}_{ik} {p}_{i}}}{1 + {\sum }_{j = 1}^{n} {e}^{{a}_{jk} - {b}_{jk} {p}_{j}}} = {q}_{0 k} {A}_{ik} {e}^{- {b}_{ik} {p}_{i}} \qquad ( 1 )$$

where qᵢₖ is the probability that a customer in segment k chooses product i, pᵢ is the price of product i, aᵢₖ is the price-independent preference value for product i in segment k (referred to as “preference value” hereafter), Aᵢₖ=e^{aik} is the price-independent “attraction” of product i in segment k, and the no-purchase probability among segment k customers is

$${q}_{0 k} = \frac{1}{1 + {\sum }_{j = 1}^{n} {A}_{jk} {e}^{- {b}_{jk} {p}_{j}}} . \qquad ( 2 )$$

The probability that a randomly selected customer belongs to segment k is wₖ with Σₖ₌₁^{m} wₖ=1, and thus the purchase probability of product i and the no-purchase probability are

$${q}_{i} = {\sum }_{k = 1}^{m} {w}_{k} {q}_{ik} = {\sum }_{k = 1}^{m} {w}_{k} \frac{{e}^{{a}_{ik} - {b}_{ik} {p}_{i}}}{1 + {\sum }_{j = 1}^{n} {e}^{{a}_{jk} - {b}_{jk} {p}_{j}}} and$$

$${q}_{0} = {\sum }_{k = 1}^{m} {w}_{k} {q}_{0 k} = {\sum }_{k = 1}^{m} {w}_{k} \frac{1}{1 + {\sum }_{j = 1}^{n} {e}^{{a}_{jk} - {b}_{jk} {p}_{j}}} = 1 - {\sum }_{i = 1}^{n} {q}_{i} .$$

Let the marginal cost of product i be cᵢ. The profit as a function of price vector p=(p1, . . . , pn) is

$$π ( p ) = {\sum }_{i = 1}^{n} ( {p}_{i} - {c}_{i} ) {q}_{i} = {\sum }_{i = 1}^{n} ( {p}_{i} - {c}_{i} ) ( {\sum }_{k = 1}^{m} {w}_{k} {q}_{ik} ) = {\sum }_{k = 1}^{m} {w}_{k} {\sum }_{i = 1}^{m} ( {p}_{i} - {c}_{i} ) {q}_{ik} = {\sum }_{k = 1}^{m} {w}_{k} {r}_{k} ( p )$$

where

$${r}_{k} ( p ) = {\sum }_{j = 1}^{n} ( {p}_{j} - {c}_{j} ) {q}_{jk}$$

is the profit contribution from a segment k customer.

Taking derivatives of the total profit with respect to prices yields

$$\frac{\partial π}{\partial {p}_{i}} = {q}_{i} + {\sum }_{j = 1}^{n} ( {p}_{j} - {c}_{j} ) {\sum }_{k = 1}^{m} {w}_{k} {b}_{ik} {q}_{ik} {q}_{jk} - ( {p}_{i} - {c}_{i} ) {\sum }_{k = 1}^{m} {w}_{k} {b}_{ik} {q}_{ik} ,$$

which leads to the following first order necessary condition for optimality:

$${p}_{i} - {c}_{i} = \frac{1}{{\sum }_{k} \frac{{w}_{k} {q}_{ik}}{{q}_{i}} {b}_{ik}} + \frac{{\sum }_{k} \frac{{w}_{k} {q}_{ik}}{{q}_{i}} {b}_{ik} {r}_{k}}{{\sum }_{k} \frac{{w}_{k} {q}_{ik}}{{q}_{i}} {b}_{ik}} . \qquad ( 3 )$$

This condition reveals a property of the optimal markup that contrasts with the basic MNL model. The following lemma shows that, even with symmetric price sensitivities across all products and all segments, the optimal mark-up is in general not equal across products. In particular, customer heterogeneity in preference value (i.e., difference in aᵢₖ values across segments), justifies differentiated markups across products (see Lemma 2 and its proof in the appendix below for details). Recall that the basic MNL model prescribes equal-markup pricing for symmetric price sensitivities regardless of preference value differences among products. This changes under the MMNL model because different segments of customers value the same product differently. Interestingly, the order of the optimal markup for different products does not necessarily follow the same sequence as the product preference value. That is, even if aᵢₖ(>aⱼₖ for all k, it is not necessarily true that the optimal markup of product i is greater than that of product j. Rather, the sequence of the optimal markup depends on how each product's preference value differs across segments, as illustrated in the following two-segment case.

Lemma 1.

Let there be two segments, i.e., k∈{A, B} and assume bᵢₖ=b for all i, k. Let p*ᵢ, i=1, . . . , n satisfy (3). Then p*ᵢ−cᵢ≥p*ⱼ−cⱼ if and only if

[(a_{iA}−a_{iB})−(a_{jA}−ajB)](r_{A}−r_{B})≥0for i≠j.

The above finding is not intuitive at first glance and we elaborate with a hypothetical “steak versus tofu” scenario. Steak and tofu are both protein-rich menu options and are often considered substitutes or competing items. Let there be two customer segments A and B. The restaurant cannot charge different prices for the same product to different segments of customers, as in our problem setting. If preference values do not differ across segments (i.e., aᵢₖ=aᵢ for all i and k), then the segments become degenerate and the MMNL model reduces to MNL; in this case condition (3) reduces to

$${p}_{i} - {c}_{i} = \frac{1}{b} + π ( p ) , ,$$

i.e., steak and tofu have the same markup. However, suppose that customers in segment A have higher preference values than customers in segment B (i.e., a_{iA}>a_{iB}), and thus for any price vector, we have r_{A}>r_{B}. Furthermore, suppose that customers have a higher preference value for steak (i=1) than tofu (i=2) (i.e., a₁ₖ>a₂ₖ), and that tofu is only attractive to segment A that is more conscious about cholesterol intake. In this example, the difference in tofu preference values across the two segments is larger than steak (i.e., a_{2A} a_{2B}>a_{1A} a_{1B}). The large difference in preference values for tofu allows the restaurant to increase profit by setting a higher markup for tofu, focusing on the high-valuation segment A of cholesterol-conscious customers and effectively pricing the low-valuation segment B out of the market. This is not the case for steak where the difference in segment preference values is smaller; the restaurant maximizes profit by setting the price of steak to appeal to both high- and low-valuation segments resulting in a lower markup compared to tofu. Therefore, the pricing strategy for tofu is of a niche product strategy whereas that for steak is a high-volume product strategy. In summary, differentiated markups in the MMNL model is due to segment differentiation. In the appendix set forth below, a two-product-two-segment numerical example is provided for further illustration.

For more than two segments and/or asymmetric IN, values, the condition of markup sequence comparison becomes intractable but it suffices to say that in general the sequence of the optimal markup does not necessarily follow the sequence of preference value.

For asymmetric price sensitivities, Gallego and Wang (2014) define

$${p}_{i} - {c}_{i} - \frac{1}{{b}_{i}}$$

as the “adjusted markup” and build an analysis upon the fact that, at optimality, the adjusted markup is the same across products under the NL model for which the basic MNL model is a special case. However, as observed in equation (3), this adjusted markup becomes product dependent under MMNL. As a result, the analysis used in Gallego and Wang (2014) does not carry through to the MMNL model.

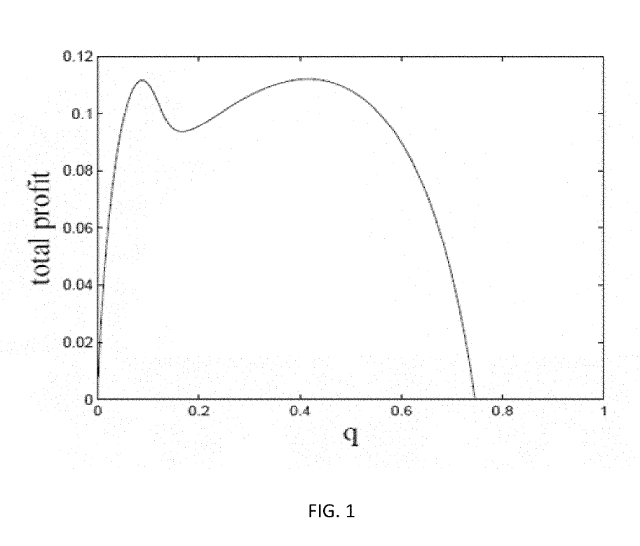

The profit function π(p) is not quasiconcave in p, even for the special case of the basic MNL (Hanson and Martin 1996). However, for the basic MNL model, the profit as a function of the quantity vector q is concave. This is shown in Dong et al. (2009) and Song and Xue (2007) for symmetric price sensitivities and in Li and Huh (2011) for more general price sensitivities. Unfortunately, as illustrated by the example in FIG. 1, such concavity property breaks down under MMNL. In this example, there is a single product and two customer segments with parameter values given by b₁₁=1, b₁₂=10, A₁₁=1, A₁₂=10, w₁=0.4, w₂=0.6. The horizontal axis in the figure is the market share of the product. It was noted that profit is not even quasiconcave in market share.

The discussion above indicates that the profit function under the MMNL model is not as well behaved as the basic MNL or NL models. Since the analytical approaches used for other logit models do not apply, a new approach was explored to characterize the profit function under MMNL, while taking advantage of the profit concavity with respect to market share of the basic MNL model.

### Characterizing the Profit Function

Let q=(q¹, . . . , q^{m}) where q^{k}=(q₁ₖ, . . . , qₙₖ) is the purchase probability vector of segment k. Inverting (1) produces,

$${p}_{i} = {g}_{ik} ( {q}^{k} ) = {log ( \frac{{A}_{ik} ( 1 - {\sum }_{j = 1}^{n} {q}_{jk} )}{{q}_{ik}} )}^{1 / {b}_{ik}} for any k \qquad ( 4 )$$

and total profit as a function of

$$q ∈ Ω = \{ {q}_{ik} \vert {\sum }_{i = 1}^{n} {q}_{ik} \leq 1 , {q}_{ik} \geq 0 , {g}_{ik} ( {q}^{k} ) \geq {c}_{i} , {g}_{i 1} ( {q}^{1} ) = … = {g}_{im} ( {q}^{m} ) ∀ i , k \} is$$

$$II ( q ) = {\sum }_{i = 1}^{n} ( {g}_{ik} ( {q}^{k} ) - {c}_{i} ) {\sum }_{l = 1}^{m} {w}_{l} {q}_{il} {\sum }_{k = 1}^{m} {w}_{k} {\sum }_{i = 1}^{n} ( {g}_{ik} ( {q}^{k} ) - {c}_{i} ) {q}_{ik} = {\sum }_{k = 1}^{m} {w}_{k} {R}_{k} ( {q}^{k} )$$

where

$${R}_{k} ( {q}^{k} ) = {\sum }_{i = 1}^{n} ( {g}_{ik} ( {q}^{k} ) - {c}_{i} ) {q}_{ik}$$

is the profit contribution from a segment k customer. Note that, for any segment, k, Rₖ(q^{k}) is concave in q^{k} (i.e., the profit function with basic MNL demand is concave in the quantity vector, as noted above). The condition gᵢₖ(q^{k})≥cᵢ in the definition of the set Ω is equivalent to

$$( {e}^{{b}_{ik} {c}_{i}} / {A}_{ik} ) {q}_{ik} + {\sum }_{j = 1}^{n} {q}_{jk} \leq 1 , ,$$

which is linear and excludes prices that lead to negative markup of a product as these cannot be optimal. To see this, assume that product i is priced below cost cᵢ. Then by raising pᵢ to cᵢ while keeping other prices unchanged, the total profit strictly improves (product i's profit increases from negative to zero and profit of all other products improves due to increased quantity). Because Π(q) is a weighted sum of concave functions, Π(q) is concave in q (Boyd and Vandenberghe 2004, page 79), suggesting that Π(q) may exhibit attractive properties for optimization. However, to assure feasible q, the present disclosure requires:

gᵢ₁(q¹)= . . . =gᵢₘ(q^{m})for all i (5)

(i.e., the price of product i is constant across segments). From (4) and (5), it follows that for any k,

$${( \frac{{A}_{ik} {q}_{0 k}}{{q}_{ik}} )}^{1 {b}_{ik}} = {( \frac{{A}_{i 1} {q}_{01}}{{q}_{i 1}} )}^{1 {b}_{i 1}}$$

and thus

$${q}_{ik} = {A}_{ik} {{q}_{0 k} ( \frac{{q}_{i 1}}{{A}_{i 1} {q}_{01}} )}^{{b}_{ik} / {b}_{i 1}}$$

### Hence,

$$1 - {q}_{0 k} = {\sum }_{j = 1}^{n} {q}_{jk} = {q}_{0 k} {\sum }_{j = 1}^{n} {{A}_{jk} ( \frac{{q}_{j 1}}{{A}_{j 1} {q}_{01}} )}^{{b}_{jk} / {b}_{j 1}} .$$

This yields the relationship

$$1 + {\sum }_{j = 1}^{n} {{A}_{jk} ( \frac{{q}_{j 1}}{{A}_{j 1} {q}_{01}} )}^{{b}_{jk} / {b}_{j 1}} = \frac{1}{{q}_{0 k}} .$$

Therefore, qᵢₖ can be expressed as a function of the vector q^{1=(q}^{₁₁}^{, q}^{₂₁}^{, . . . , q}^{ₙ₁}⁾ for all i, k:

$${q}_{ik} = \frac{{{A}_{ik} ( \frac{{q}_{i 1}}{{A}_{i 1} {q}_{01}} )}^{{b}_{ik} / {b}_{i 1}}}{1 + {\sum }_{j = 1}^{n} {{A}_{jk} ( \frac{{q}_{j 1}}{{A}_{j 1} {q}_{01}} )}^{{b}_{jk} / {b}_{j 1}}} = \frac{{{A}_{ik} ( \frac{{q}_{i 1}}{{A}_{i 1} ( 1 - {\sum }_{l = 1}^{n} {q}_{l 1} )} )}^{{b}_{ik} / {b}_{i 1}}}{1 + {\sum }_{j = 1}^{n} {{A}_{jk} ( \frac{{q}_{j 1}}{{A}_{j 1} ( 1 - {\sum }_{l = 1}^{n} {q}_{l 1} )} )}^{{b}_{jk} / {b}_{j 1}}} .$$

### Define

$$\begin{matrix}{f}_{k} ( {q}^{1} ) := ( \frac{{{A}_{1 k} ( \frac{{q}_{11}}{{A}_{1 \; 1} ( 1 - {\sum }_{l = 1}^{n} {q}_{l 1} )} )}^{{b}_{1 k} / {b}_{11}}}{1 + {\sum }_{j = 1}^{n} {{A}_{jk} ( \frac{{q}_{j 1}}{{A}_{j 1} ( 1 - {\sum }_{l = 1}^{n} {q}_{l 1} )} )}^{{b}_{jk} / {b}_{j 1}}} , … , \frac{{{A}_{nk} ( \frac{{q}_{n 1}}{{A}_{n 1} ( 1 - {\sum }_{l = 1}^{n} {q}_{l 1} )} )}^{{b}_{n k} / {b}_{n 1}}}{1 + {\sum }_{j = 1}^{n} {{A}_{jk} ( \frac{{q}_{j 1}}{{A}_{j 1} ( 1 - {\sum }_{l = 1}^{n} {q}_{l 1} )} )}^{{b}_{jk} / {b}_{j 1}}} ) , \\ f ( {q}^{1} ) := ( {f}_{1} ( {q}^{1} ) , … , {f}_{m} ( {q}^{1} ) ) , \\ {\hat{R}}_{k} ( {q}^{1} ) := {R}_{k} ( {f}_{k} ( {q}^{1} ) ) , and & ( 7 ) \\ \hat{\prod } ( {q}^{1} ) := {\sum }_{k = 1}^{m} {w}_{k} {\hat{R}}_{k} ( {q}^{1} ) = {\sum }_{k = 1}^{m} {w}_{k} {R}_{k} ( {f}_{k} ( {q}^{1} ) ) = \prod ( {f}_{1} ( {q}^{1} ) , … , {f}_{m} ( {q}^{1} ) ) = \prod ( f ( {q}^{1} ) ) . & ( 8 )\end{matrix}$$

Thus, the n×m-dimensional profit maximization problem

$${max}_{q ∈ Ω} \prod ( q )$$

is equivalent to the following n-dimensional optimization problem:

$${max}_{{q}^{1} ∈ {Ω}_{1}} \hat{\prod } ( {q}^{1} )$$

where Ω₁={q¹|Σᵢ₌₁ⁿqᵢ₁≤1, qᵢ₁≥0, gᵢ₁(q¹)≥cᵢ∀i}. In other words, the total profit to a function of the segment 1 quantity vector q¹ is transformed

To address the question of whether the profit function \hat{Π}(q¹) defined over convex set Ω₁ is well-behaved (e.g., quasiconcave), the simple case of a single product with symmetric price sensitivities across segments is considered. For this case, each segment is distinguished by a unique value of the price-independent attraction parameter A₁ₖ. It is shown that the introduction of multiple segments in this simple setting (i.e., via the introduction of distinct price-independent attraction parameters) causes the concave structure of the MNL profit function to break down. The following proposition shows that is concave if the variation in A₁ₖ values is within a certain range. After the proposition, an example is provided that illustrates how the profit function shifts from concave to nonconcave as variation in A₁ₖ values increases.

Proposition 1. For a single product MMNL model, if

$$\frac{{max}_{k} {A}_{1 k}}{{min}_{k} {A}_{1 k}} \leq 2$$

and b₁ₖ=b for all k, then \hat{Π}(q¹) is concave on Ω₁.

FIGS. 2A and 2B illustrate functions \hat{R}₁(q¹), \hat{R}₂(q¹), and \hat{Π}(q¹) for a pair of problem instances with one product and two segments. Parameter values are identical except for the value of A₁₂; A₁₂/A₁₁≈1.6 in FIG. 2(a) and A₁₂/A₁₁≈2981 in FIG. 2(b). FIG. 2B shows that even with symmetric price sensitivities, when the variation in Aₗₖ values is sufficiently large, the profit function is not quasiconcave and uniqueness of the optimal solution is not guaranteed. Recall that the uniqueness conditions of the optimal prices under the NL model essentially constrain the degree of asymmetry in the price-sensitivity parameters. Here it was noted that symmetry of price sensitivity alone does not ensure a unique solution under MMNL. Proposition 1 and the examples in FIGS. 2A and 2B hint that the condition for a unique price solution requires that the difference between segment-specific attractiveness be limited. The next proposition formalizes this idea for the multi-product case.

Proposition 2. Assume bᵢₖ=bᵢ for all k. There exists X̅=(X̅₁, X̅₂, . . . , X̅ₙ)>1 such that, if

$$\frac{{max}_{k} {A}_{ik}}{{min}_{k} {A}_{ik}} < \overline{{λ}_{i}}$$

for all i, then \hat{Π}(q¹) is concave on Ω₁ and the optimal price vector is unique.

Proposition 2 implies that there is a neighborhood around λ=1 where the profit function is concave in q^{l}. Outside this neighborhood, i.e., when the segments are sufficiently asymmetric, the profit function may not be concave. As we observe in Proposition 2 and its proof, in general, accurate identification of this neighborhood is very difficult when n>1. This complexity inhibits closed-form characterization of λ̅. Even for a specific problem instance (defined by a set of parameter values), the numerical evaluation of the signs of the diagonal and leading principle minors of the Hessian to test whether it is negative definite over Ω₁, is not promising (i.e., only a finite subset of points in Ω₁ can be evaluated).

Define \tilde{Π}(q^{m}) as the total profit as a function of q^{m}, similar to the definition of \tilde{Π}(q¹). While the total profit is in general not concave in either q¹ or q^{m}, the following proposition illustrates that in the case when bᵢₖ=bᵢ (i.e., when the known segment differences are mainly due to taste variations for product features and performance), the profit is bounded from above and below by two concave functions. Let:

$$\overline{\prod } ( {q}^{1} ) = {\sum }_{i} \frac{{q}_{i 1}}{{b}_{i}} [ log {A}_{i 1} - log {q}_{i 1} + log ( 1 - {\sum }_{j} {q}_{j 1} ) - {b}_{i} {c}_{i} ] {\sum }_{k} {w}_{k} {A}_{ik} / {A}_{i 1}$$

$$\underline{\prod } ( {q}^{m} ) = {\sum }_{i} \frac{{q}_{im}}{{b}_{i}} [ log {A}_{im} - log {q}_{im} + log ( 1 - {\sum }_{j} {q}_{jm} ) - {b}_{i} {c}_{i} ] {\sum }_{k} {w}_{k} {A}_{ik} / {A}_{im} ,$$

Proposition 3. Assume bᵢₖ=bᵢ for all k. In addition, assume Aᵢₗ≤Aᵢₖ≤Aᵢₘ for all k. (i) Π̅(q¹) is concave in q¹ and Π(q^{m}) is concave in q^{m}. (ii) \hat{Π}(q¹)≤Π̅(q¹) and \tilde{Π}(q^{m})≥Π(q^{m}).

Therefore, in this case, the total profit is bounded by functions that are easy to optimize, yielding lower and upper bounds on the optimal total profit. These bounds are provided in Corollary 1 in the appendix.

To further characterize the profit function, it was noted that both segment-profit functions (\hat{R}₁(q¹), \hat{R}₂(q¹)) in FIG. 2(b) are quasiconcave, even though \hat{Π}(q¹) is not quasiconcave. In the following proposition, it will be shown that this feature of the segment-profit functions holds in general.

Proposition 4. For the MMNL model, \hat{R}ₖ(q¹) is quasiconcave on Ω₁ for all k, and \hat{R}₁(q¹) is concave on Ω₁.

To prove Proposition 4, the function fₖ(q¹) is decomposed into more elementary functions, and the present disclosure shows that each of these functions preserves convexity. This implies that the set {fₖ(q^{l})|q¹ ∈Ω₁} is a convex set. Using the fact that the inverse image of a convex set under linear-fractional transformation is convex, and by showing that a certain power transformation also preserves convexity of a set, it was proven that the superlevel set of \hat{R}ₖ-is convex, thereby establishing quasiconcavity of \tilde{R}ₖ.

Proposition 4 tells us that the MMNL profit function \tilde{Π}(q¹) is a weighted sum of quasi-concave segment-profit functions, at least one of which is assured to be concave (i.e., \hat{R}₁(q¹)). While the weighted sum of concave functions is concave (with a unique stationary point), there is no such assurance that the weighted sum of quasiconcave functions is quasiconcave (e.g., FIG. 2B). Nevertheless, the relatively well-behaved structure of the segment-profit functions in the total profit function

$$\hat{\prod } ( {q}^{1} ) = {\sum }_{k = 1}^{m} {w}_{k} {\hat{R}}_{k} ( {q}^{1} )$$

hints that \tilde{Π}(q¹) may exhibit a unique stationary point over a range of MMNL parameter values and may help explain the favorable computational results described herein.

### Optimization Algorithms

Proposition 4 characterizes the total profit under the MMNL model as a weighted sum of quasiconcave segment profit functions. Propositions 1 and 2 indicate that when the degree of segment asymmetry is sufficiently small, the total profit is concave in q¹ and a unique optimal solution is guaranteed. When the degree of asymmetry becomes sufficiently large, the total profit becomes nonconcave or even nonquasiconcave, as demonstrated in FIGS. 2A and 2B. Therefore, different algorithms are proposed for addressing these two scenarios. In this context, a scenario is defined as a set of variables determining the concavity of the profit function and is used to generate the optimal price. A quasiconcave function defines one scenario, while a function that is not quasiconcave defines a second scenario. If the profit function is known to be quasiconcave (e.g., with high degree of symmetry across segments), then the following bisection search algorithm is assured to return an optimal solution.

Algorithm 1 (bisection search). Step 1. Start with an initial interval [\hat{Π}_{L}, \hat{Π}_{H}] in which the optimum must lie.

Step 2. Let t=(\hat{Π}_{L}+\hat{Π}_{H})/2 and solve the feasibility problem: find q¹∈Ω₁ s.t. \hat{Π}(q¹)≥t. Note that the feasibility problem can be formulated as minimizing a constant over the convex set Sₜ={q¹|q¹∈Ω₁, \hat{Π}(q¹)≥t} and solved using a convex optimization procedure; Sₜ is convex because Ω₁ is convex and the constraint \hat{Π}(q¹)≥t represents a superlevel set of \hat{Π}(q¹), which due to quasiconcave \hat{Π}(q¹), is convex (see Boyd and Vandenberghe 2040, p. 95.)

Step 3. If the above problem is feasible, then \hat{Π}*≥t and set \hat{Π}_{L}=t; otherwise \hat{Π}*<t and set \hat{Π}_{H}=t.

Step 4. Repeat Steps 2-3 until \hat{Π}_{L} and \hat{Π}_{H} converges.

If the profit function is not quasiconcave, then the feasibility problem in Step 2 is not convex and the algorithm may not find a feasible solution even when one exists. In this case, Algorithm 1 is not assured to return an optimal solution. Instead, we may use a gradient descent procedure to obtain a price vector that is a stationary point of the profit function. Let h(p)=−π(p), which is the function to minimize in a gradient descent algorithm. Let \hat{p}ᵢ=ₚi−cᵢ (margin of product i) and recall that

$${r}_{k} = {\sum }_{i = 1}^{n} {\hat{p}}_{i} {q}_{ik} .$$

Note that

$$\frac{\partial {q}_{ik}}{\partial {p}_{i}} = - {b}_{ik} {q}_{ik} ( 1 - {q}_{ik} ) , \frac{\partial {q}_{jk}}{\partial {p}_{i}} = {b}_{ik} {q}_{ik} {q}_{jk} for i \neq j , \\ \frac{\partial {q}_{i}}{\partial {p}_{i}} = - {\sum }_{k = 1}^{m} {w}_{k} {b}_{ik} {q}_{ik} ( 1 - {q}_{ik} ) , \frac{\partial {q}_{j}}{\partial {p}_{i}} = {\sum }_{k = 1}^{m} {w}_{k} {b}_{ik} {q}_{ik} {q}_{jk} for i \neq j .$$

Thus:

$$\frac{\partial h ( \hat{p} )}{\partial {\hat{p}}_{i}} = - \frac{\partial π ( p )}{\partial {p}_{i}} = {\hat{p}}_{i} {\sum }_{k = 1}^{m} {w}_{k} {b}_{ik} {q}_{ik} - {\sum }_{k = 1}^{m} {w}_{k} {b}_{ik} {q}_{ik} {\sum }_{j = 1}^{n} {\hat{p}}_{j} {q}_{jk} - {q}_{i} = ( {\sum }_{k = 1}^{m} {w}_{k} {b}_{ik} {q}_{ik} ) [ {\hat{p}}_{i} - {\sum }_{k = 1}^{m} ( \frac{{w}_{k} {b}_{ik} {q}_{ik}}{{\sum }_{l = 1}^{m} {w}_{l} {b}_{il} {q}_{il}} ) {r}_{k} - \frac{1}{{\sum }_{k = 1}^{m} ( \frac{{w}_{k} {q}_{ik}}{{q}_{i}} ) {b}_{ik}} ] .$$

Algorithm 2 (gradient descent). Step 1. Select values for an initial margin vector, e.g., \hat{p}¹=(1/b₁₁, . . . , 1/bₙ₁) and let t=1.

Step 2. At the t^{th} iteration, compute the direction vector d^{t} as

$${d}_{i}^{t} = \frac{1}{{\sum }_{k = 1}^{m} ( \frac{{w}_{k} {q}_{ik}}{{q}_{i}} ) {b}_{ik}} + {\sum }_{k = 1}^{m} ( \frac{{w}_{k} {b}_{ik} {q}_{ik}}{{\sum }_{l = 1}^{m} {w}_{l} {b}_{il} {q}_{il}} {\sum }_{j = 1}^{n} {\hat{p}}_{j}^{t} {q}_{jk} ) - {\hat{p}}_{i}^{t} for all i ,$$

where qᵢₖ, q₀ₖ are functions of \hat{p}^{t}, and compute the step size α^{t}∈[0, 1] as

$${α}^{t} = {arg min}_{α ∈ [ 0 , 1 ]} h ( {\hat{p}}^{t} + α {d}^{t} ) .$$

Step 3. Compute the new margin vector as \hat{p}^{t+1}=\hat{p}^{t}+α^{t}d^{t}

Step 4. Increase t by 1 and repeat steps 2-4 until the markup vector converges.

Proposition 5. Algorithm 2 converges to a stationary point of the price optimization problem.

Since a unique optimal solution is not guaranteed when the profit function is not quasi-concave, it is necessary to apply Algorithm 2 with different starting price vectors to avoid a suboptimal stationary point solution. In particular, it can be shown from equation (3) that the optimal price pᵢ, i=1, 2, . . . , n must be bounded in the interval

$$[ {c}_{i} + \frac{1}{{max}_{k} {b}_{ik}} \vert {c}_{i} + \frac{1}{{max}_{k} {b}_{ik}} + {max}_{k} {ρ}_{k} ] \qquad ( 9 )$$

where pₖ is the optimal profit from a segment k customer if prices of all products are set to maximize segment k profit only. Specifically, pₖ solves the single-variable equation (Li and Huh 2011, Theorem 2)

$${ρ}_{k} = {\sum }_{j = 1}^{n} \frac{{e}^{{a}_{jk} - {b}_{jk} {c}_{jk} - 1} {e}^{- {b}_{jk} {ρ}_{k}}}{{b}_{jk}} .$$

This single-variable equation is easily solved with a bisection search as the left side monotonically increases in pₖ and the right side monotonically decreases in pₖ. Therefore, by randomly generating starting price vectors from the above interval and applying Algorithm 2, one can obtain additional stationary points and compare the profits to identify the best among them. In theory, as long as the random distribution used to generate the starting values does not lead to a nonzero probability of repeatedly missing a subset with positive volume, the search will converge to the global optimal. For example, a uniform distribution satisfies this requirement. In practice, with reasonably sufficient number of random starting values, a global optima can be achieved with high confidence.

### Efficient Frontier of Profit and Market Share

A practical concern in pricing is balancing profit and market share objectives. For example, senior management constantly shifts discussion between profit maximization and market share expansion. On one hand, the profit-maximizing pricing solution may not meet the firm's ambition on market share; on the other hand, the market share-maximizing prices reduce profit margins to nil which is also far from ideal. With this in mind, a description is made for how the optimization algorithm can be adapted to yield the efficient frontier of optimal profit by market share, allowing a firm to choose the sweet spot that reflects its market strategy.

Let \ddot{q} denote the firm's target total share and consider the problem

$${max}_{p} \{ π ( p ) \vert {\sum }_{j = 1}^{n} {q}_{j} ( p ) = \overline{q} \} ,$$

which can be equivalently expressed as maximizing the Lagrangian function, i.e.,

$${max}_{p , γ} L ( p , γ ) = π ( p ) + γ ( {\sum }_{j = 1}^{n} {q}_{j} ( p ) - \overline{q} ) .$$

Let γ*(q̅) denote the Lagrangian multiplier for a given target total share value q̅. Note that γ*: (0, 1)→(−∞, ∞) is a strictly increasing function (e.g., γ*(q^{o})=0 where q^{o}=Σⱼⁿqⱼ(p^{o}) and p^{o} denotes the optimal unconstrained price vector). Thus, the efficient frontier is generated by solving the following problem

$${L}^{*} ( γ ) = {max}_{p} \{ π ( p ) + γ ( {\sum }_{j = 1}^{n} {q}_{j} ( p ) - \overline{q} ) \}$$

for differing values of γ. Letting

$${p}^{*} ( γ ) = {arg max}_{p} \{ π ( p ) + γ {\sum }_{j = 1}^{n} {q}_{j} ( p ) \} ,$$

the efficient frontier is given by the curve (Σⱼ₌₁ⁿqⱼ(p*(γ)), π(p*(γ))).

Next, how the gradient search method can be used to obtain the efficient frontier is illustrated. The gradient descent algorithm described above (Algorithm 2) identifies the gradient function for the special case of γ=0. In this section, the generalized gradient function is identified. Let h^{L}(p)=−L(p) and define \hat{p}ᵢ=pᵢ−cᵢ.

$$\frac{\partial {h}^{L} ( p , γ )}{\partial {p}_{i}} = - \frac{\partial L ( p , γ )}{\partial {p}_{i}} = ( {\hat{p}}_{i} + γ ) {\sum }_{k = 1}^{m} {w}_{k} {b}_{ik} {q}_{ik} - {\sum }_{k = 1}^{m} {w}_{k} {b}_{ik} {q}_{ik} {\sum }_{j = 1}^{n} ( {\hat{p}}_{j} + γ ) {q}_{jk} - {q}_{i} = ( {\sum }_{k = 1}^{m} {w}_{k} {b}_{ik} {q}_{ik} ) \{ {\hat{p}}_{i} + γ - {\sum }_{k = 1}^{m} [ \frac{{w}_{k} {b}_{ik} {q}_{ik}}{{\sum }_{𝓁 = 1}^{m} {w}_{𝓁} {b}_{i 𝓁} {q}_{i 𝓁}} {\sum }_{j = 1}^{n} ( {\hat{p}}_{j} + γ ) {q}_{jk} ] - \frac{1}{{\sum }_{𝓁 = 1}^{m} \frac{{w}_{𝓁} {q}_{i 𝓁}}{{q}_{i}} {b}_{i 𝓁}} \} = ( {\sum }_{k = 1}^{m} {w}_{k} {b}_{ik} {q}_{ik} ) [ {\hat{p}}_{i} - {\sum }_{k = 1}^{m} ( \frac{{w}_{k} {b}_{ik} {q}_{ik}}{{\sum }_{𝓁 = 1}^{m} {w}_{𝓁} {b}_{i 𝓁} {q}_{i 𝓁}} ) ( {\sum }_{j = 1}^{n} ( {\hat{p}}_{j} {q}_{jk} - γ {q}_{0 k} ) ) - \frac{1}{{\sum }_{𝓁 = 1}^{m} \frac{{w}_{𝓁} {q}_{i 𝓁}}{{q}_{i}} {b}_{i 𝓁}} ] .$$

The following algorithm solves for a stationary point for the optimization of L(p|γ) for a given γ.

Algorithm 3 (gradient descent for efficient frontier). Step 1. Select values for an initial margin vector, e.g., \hat{p}¹==(1/b₁₁, . . . , 1/bₙ₁) and let t=1.

Step 2. At the t^{th} iteration, compute the direction vector d^{t} as

$${d}_{i}^{t} = \frac{1}{{\sum }_{k = 1}^{m} ( \frac{{w}_{k} {q}_{ik}}{{q}_{i}} ) {b}_{ik}} + {\sum }_{k = 1}^{m} ( \frac{{w}_{k} {b}_{ik} {q}_{ik}}{{\sum }_{l = 1}^{m} {w}_{l} {b}_{il} {q}_{il}} ) ( {\sum }_{j = 1}^{n} {\hat{p}}_{j}^{t} {q}_{jk} - γ {q}_{0 k} ) - {\hat{p}}_{i}^{t} for all i$$

where qᵢₖ, q₀ₖ are functions of \hat{p}^{t}, and compute the step size αⁱ∈[0, 1] as

$${α}^{t} = {arg min}_{α ∈ [ 0 , 1 ]} h ( {\hat{p}}^{t} + α {d}^{t} ) .$$

Step 3. Compute the new margin vector as \hat{p}^{t+1}=\hat{p}^{t}+α^{t}d^{t}.

Step 4. Increase t by 1 and repeat steps 2-4 until the markup vector converges.

Proposition 6. Given γ, Algorithm 3 converges to a stationary point of L(p|γ).

### Applications

In the following, various applications of the pricing solution under MMNL are described. For example, currently at Corporation A, product prices, along with performance expectations must be announced to customers well in advance of product release for these customers to make product design and purchasing decisions. As a direct consequence, the company's pricing decisions are often performed with incomplete/uncertain information and are often made in light of the prices of the pre-vious generation of Corporation A products qualitatively accounting for additional features in the new generation. Internally, there is a strong desire to quantify the impact of pricing decisions with available data.

The model is applied to Intel's microprocessor stock keeping units (SKUs) used in computer servers. Sales data of 16 SKUs spanning four generations of products were used as the initial study of the tools developed. In particular, the first three generations of products (13 SKUs) were used to parameterize the demand model and the fourth generation of products (3 SKUs) were used to test the demand model; prices are optimized for the three SKUs of generation 4 products. Products that are sold concurrently directly compete and form a choice set. Quarterly sales are scaled down by a constant factor and converted to one or multiple choice occasions based on the sales volume. For example, every 200 units is treated as one choice occasion. Then quarterly sales with a volume of 800 units are converted to four choice occasions with the chosen product as the choice decision among the corresponding choice set.

Customers are categorized into seven segments and the weights wₖ, k=1, 2, . . . , 7 are computed based on historical purchasing volumes. The seven customer categories correspond to groupings used by Intel's sales division.

The list of independent variables considered includes processor cores, processor base frequency, TDP (a power consumption index), turbo frequency, performance (a commonly-adopted benchmark score from the Standard Performance Evaluation Corporation), cache, price and price/performance. The independent variables are not limited to those defined by the example of Corporation A's products. These independent variables can be any that describe relevant features of any product being sold and whose optimal price must be determined. The regressors for each customer segment are chosen based on the training and test data prediction accuracy. The SAS multinomial discrete choice (MDC) procedure is used to obtain segment-specific coefficients. Data fitting and parameterization details are provided in the appendix which includes the coefficient table, as well as the training and test errors.

The regression coefficients and the independent variable values are then used to compute values for aᵢₖ and bᵢₖ. In particular, the non-price attributes of the products and the corresponding coefficients are used to obtain aᵢₖ, i.e., aᵢₖ=βₖxᵢ where xᵢ is the vector of attribute values and βₖ is the vector of coefficients. The price terms (price and price/performance) are used to compute bᵢₖ. values, i.e.,

$${b}_{ik \cdot } = - ( {β}_{k}^{p} + \frac{{β}_{k}^{I}}{{performance}_{i}} )$$

where βₖ^{p} and βₖ^{I} are the co-efficients for price and price/performance respectively, and performance; is the performance of product i. Since the no-purchase incidences are not observable, the MDC procedure is run with only Corporation Aproduct alternatives.

For price optimization; however, the no-purchase utilities need to be accounted for. In the market of server processors, Corporation A products have dominant performances and thus a segment-specific no-purchase option is determined by computing the segment-specific utilities of recently retired Corporation Aproducts comparable to the current choice set (i.e., retired products which would have belonged to the current choice set if still available), using the coefficients obtained from the regression. The aᵢₖ values of Corporation A products are then normalized so that the corresponding no-purchase utility is zero (i.e., subtract the segment-specific no-purchase utility for each segment from the original aᵢₖ values). Lastly, the normalized aᵢₖ values and bᵢₖ values are fed to the price optimization algorithm to compute the optimal price vector. The normalized price-independent utilities, i.e., aᵢₖ values, and the price sensitivities of generation 4 products are given in Table 2 and Table 3 respectively. The segment weights (wₖ's) are given in Table 4. In this application, the marginal costs cᵢ's are set to zero due to Intel's high volume production in which processors are produced in large lots and fixed cost dominates.

TABLE 2
aᵢₖ Values.

| | k | | | | | | |
|---|---|---|---|---|---|---|---|
| i | 1 | 2 | 3 | 4 | 5 | 6 | 7 |
| 1 | −1.0334 | 3.2480 | −0.9336 | 1.7094 | 0.4187 | −0.8904 | −0.9804 |
| 2 | 0.7840 | 4.7161 | −0.3438 | 1.8777 | 2.1771 | −0.4310 | −0.4907 |
| 3 | 6.0054 | 3.8771 | 1.3506 | 2.3611 | 1.1723 | 0.8889 | 0.9163 |

TABLE 3
bᵢₖ Values.

| | k | | | | | | |
|---|---|---|---|---|---|---|---|
| i | 1 | 2 | 3 | 4 | 5 | 6 | 7 |
| 1 | 0.00416 | 0.01840 | 0.00525 | 0.01165 | 0.01015 | 0.00325 | 0.00331 |
| 2 | 0.00312 | 0.01354 | 0.00394 | 0.00874 | 0.00639 | 0.00244 | 0.00248 |
| 3 | 0.00181 | 0.00744 | 0.00229 | 0.00508 | 0.00167 | 0.00142 | 0.00144 |

TABLE 4
wₖ Values

| | k | | | | | | |
|---|---|---|---|---|---|---|---|
| | 1 | 2 | 3 | 4 | 5 | 6 | 7 |
| wₖ | 0.0753 | 0.1126 | 0.1285 | 0.1180 | 0.0859 | 0.2842 | 0.1953 |

Algorithm 3 is implemented for Corporation A's application to obtain the profit-market share efficient frontier, and the corresponding optimal prices for any given market share target. For each share target, we use 30 randomly selected starting values and convergence to a stationary point is achieved for all instances. Convergence takes between 18 and 41 iterations.

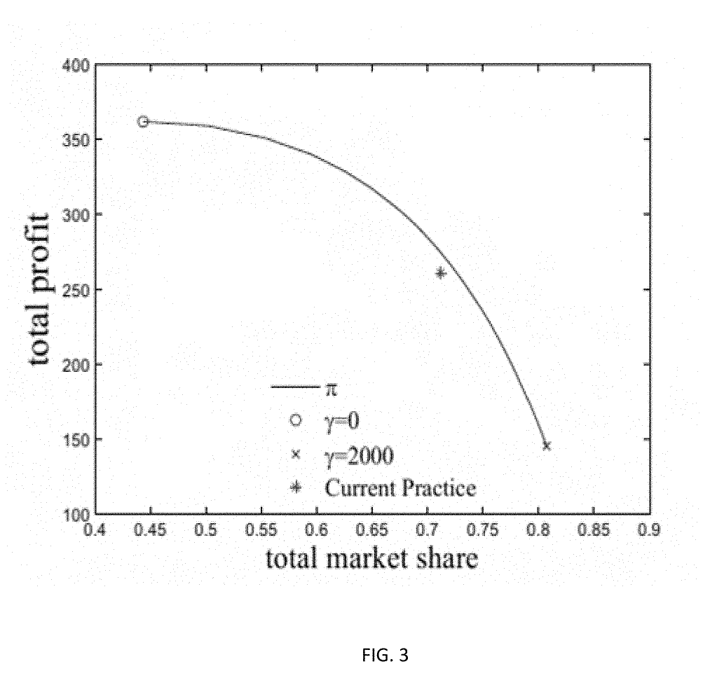

FIG. 3 illustrates the efficient frontier of profit versus total market share. Recall that γ is the Lagrangian multiplier associated with a given total share value. The case of γ=0 corresponds to the unconstrained optimal solution. The profit and market share under Intel's current prices are noted with * in FIG. 3. As the desired total market share increases (equivalently, as γ increases), the optimal achievable profit decreases and the profit decline is steeper at higher market shares. Interestingly, Intel's current prices sit quite close to the efficient frontier. That is, if Corporation A is to maintain the current total market share, the current prices perform well. The room for improvement without compromising on market share is 5.3% (i.e., moving from current practice vertically up to the efficient frontier). Alternatively, Corporation A may improve the total market share by 2.1% without compromising profit by moving from the current practice horizontally to the efficient frontier. Table 5 presents these options.

TABLE 5

| Price | Current | Profit-improving | Share-improving |
|---|---|---|---|
| p1 | $207 | $120 | $107 |
| p2 | $299 | $182 | $169 |
| P3 | $410 | $649 | $601 |
| total profit | $261.2 | $275.1 | $261.2 |
| total market share | 0.7117 | 0.7117 | 0.7265 |

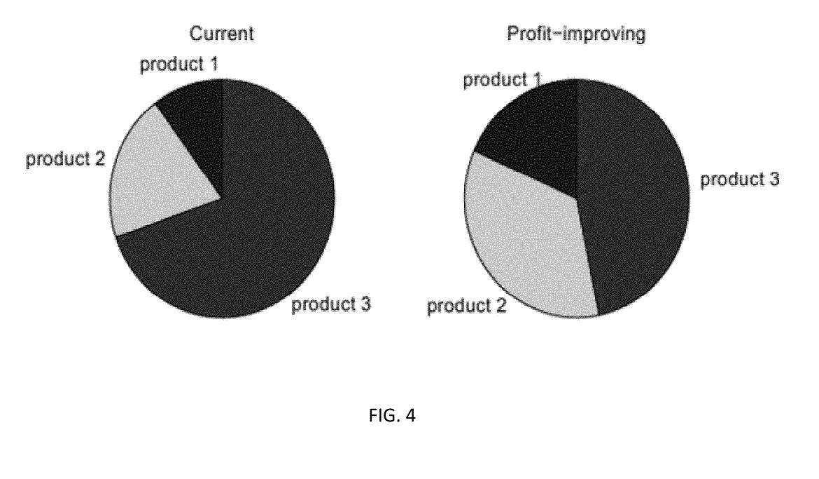

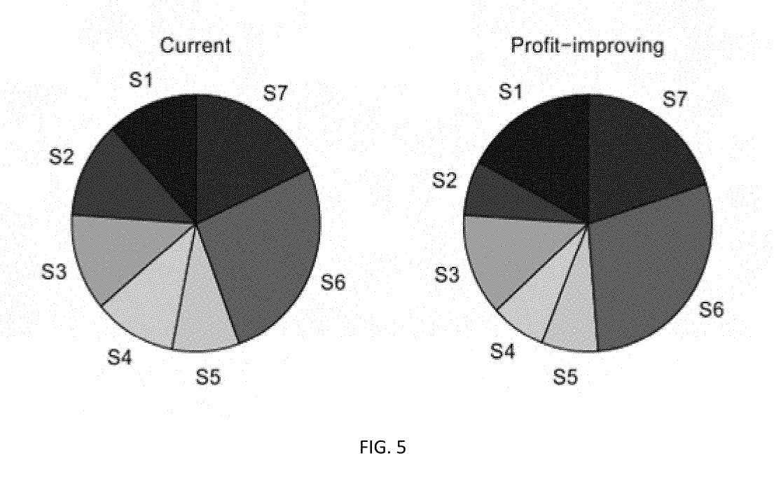

FIG. 4 illustrates the distribution of sales among the three products under the current and the profit-improving prices respectively. FIG. 5 illustrates how the total profit distributes among different customer segments, which reveals an important underlying mechanism that drives profit improvement. Note that, compared to the distribution under the current prices, profit shares for segments 1, 3, 6 and 7 increase, while those for segments 2, 4, and 5 decrease under the profit-improving prices. That is, by adjusting the product prices to tailor to the preferences of certain customers, Corporation A can generate a larger total profit. Therefore, profit improvement is in part a consequence of exploiting segment differences and using price as a means for redistributing sales and profits among customer segments. Segment-specific sales distribution provides additional supporting evidence for this and is given in the appendix below.

Corporation A's management was pleased to observe that the current prices perform well (i.e., close to the efficient frontier). They were also enthusiastic about the ability to visualize where Corporation A was positioned along the entire spectrum of the efficient frontier and understand how movement along the efficient frontier would help or hurt Intel's objective. For example, while adopting an unconstrained price solution (noted by “o” in FIG. 3) can lead to significant one-time profit increase, losing a substantial amount of market share is not necessarily the strategy that Corporation A wishes to pursue. The efficient frontier allows Corporation A to choose a pricing strategy that effectively balances its goals of profit versus market share.

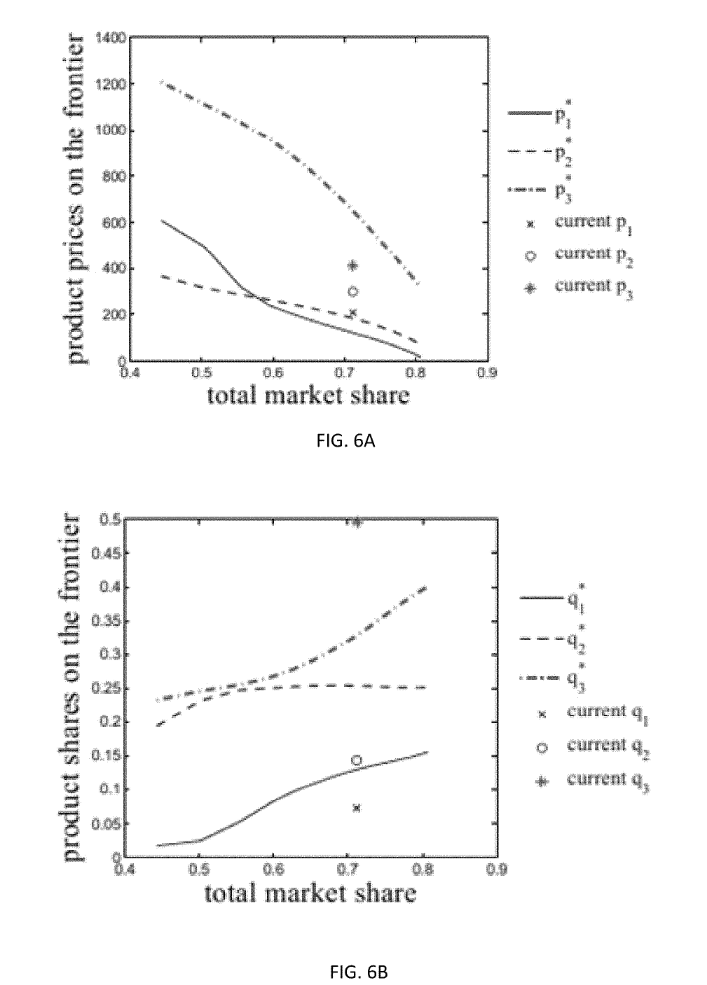

FIGS. 6A and 6B present the corresponding prices and product shares along the efficient frontier. The current prices and product shares are also noted in the figures.

Two observations are salient. (1) As the target total market share increases, the optimal prices of all products decrease and the resulting product shares increase, which is expected. (2) At levels close to the current total market share, the sequence of the optimal prices are consistent with the order of the preference values of the products, i.e., products with higher a values are priced higher; however, when the target market share is low, the price sequence of products 1 and 2 flips.

Observation (2) is counterintuitive. Lemma 1 provides a plausible theoretical explanation for the price sequence reversal. In the case of Corporation Aproducts, product 1's preference values are low and are often significantly lower than the no-purchase option (see Table 2). Therefore, it is unlikely to be a high-volume product. However, when market share is less of a concern, the firm can take advantage of the segment differences and essentially turn it from a “cheap” product into a “niche” product by charging a higher price and only focusing on customers who value it more than others.

The methods presented in this disclosure serve multiple purposes at Corporation A, but may also be applied to other businesses. First, it provides a new alternative for market share prediction among Corporation A products for different customer segments, adding to the suite of independent demand forecasting tools. Second, it optimizes product prices based on segment-specific customer preferences revealed through sales data, a capability that Corporation A's current pricing tools include only heuristically. Third, it enables the company to quantitatively balance the tradeoff between profit and market share. Furthermore, the ability to locate the current pricing strategy relative to the efficient frontier allows Corporation A to identify practical improvement opportunities.

It has been shown that the well-known equal markup property identified for the MNL model with symmetric sensitivities does not hold under MMNL even for entirely symmetric price sensitivities across all products and all segments. This suggests that customer heterogeneity in preferences towards price-independent product attractiveness alone justifies differentiated markups. In addition, the concavity property with respect to the choice probability vector shown in prior research for the MNL and NL model breaks down under MMNL and the present disclosure demonstrates with examples how the profit function might shift from concave to nonconcave functions as the model primitives change. The analysis that leads to a unique solution under MNL or NL does not carry through to MMNL. In this disclosure, the profit function under MMNL is characterized as the sum of a set of quasiconcave functions and efficient optimization algorithms for the pricing problem are presented. In addition, a solution method is presented for computing the efficient frontier of profit against total market share, which broadens the applicability of the model. Moreover, these methods are applied using data from Corporation A and show that, by adjusting the prices of the products to tailor to the preferences of different customer segments, Corporation A could redistribute sales and profits among the segments to generate a larger total profit. The efficient frontier of profit against market share enables Corporation A to examine its pricing decision in light of the firm's desired balance between the two goals.

The MMNL model can approximate any discrete choice model consistent with random utility maximization (RUM) to any degree of precision. Thus, the theoretical results and solution approaches derived in this disclosure suggest a path to solving the pricing problem under any discrete choice model that is consistent with RUM.

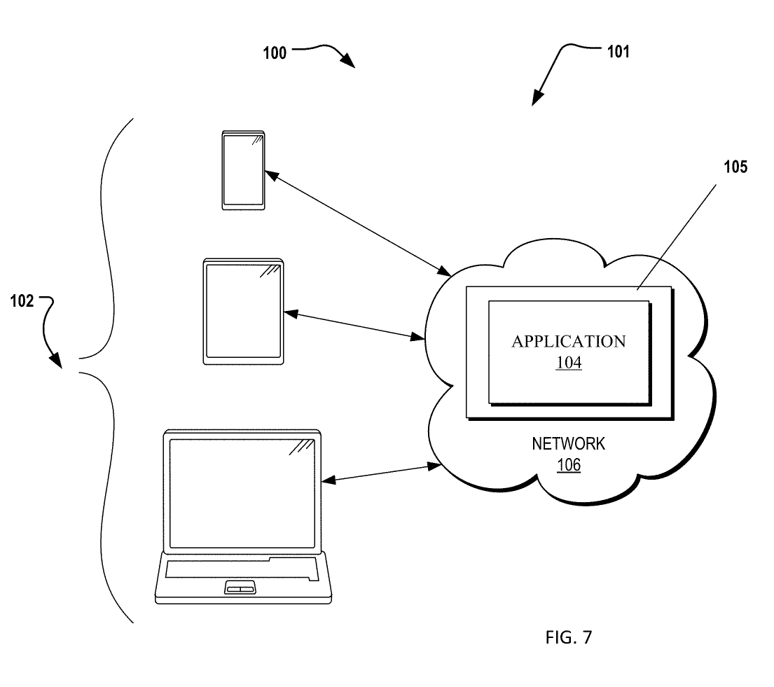

FIG. 7 is a network environment 100 for illustrating a computing network that may be configured to implement a pricing solution system 101. The pricing solution system 101 may be generally comprised of one or more computing devices configured with aspects of the MMNL model and optimization algorithms described herein. In other words, the aforementioned computations for generating an optimal price or optimal price solution can be translated to computing code and installed to one or more computing devices, thereby configuring such computing devices with functionality for generating an optimal price or optimal price solution by, e.g., accessing customer segment information and input data, and applying the input data to the MMNL model and optimization algorithms to generate an output in the form of an optimal price or optimal price solution.

In some embodiments, the network environment of the pricing solution system 101 may include a plurality of user devices 102. The user devices 102 may access an application 104 which may generally embodies features of the pricing solution system 101 and makes at least some of the features accessible to the user devices 102 via a network 106. In some embodiments, the application 104 is executed and generally managed by a computing device 105 such as a server, or SaaS (Software as a service) provider in a cloud. The user devices 102 may be generally any form of computing device capable of interacting with the network 106 to access the application 104 and implement the pricing solution system, such as a mobile device, a personal computer, a laptop, a tablet, a work station, a smartphone, or other internet-communicable device.

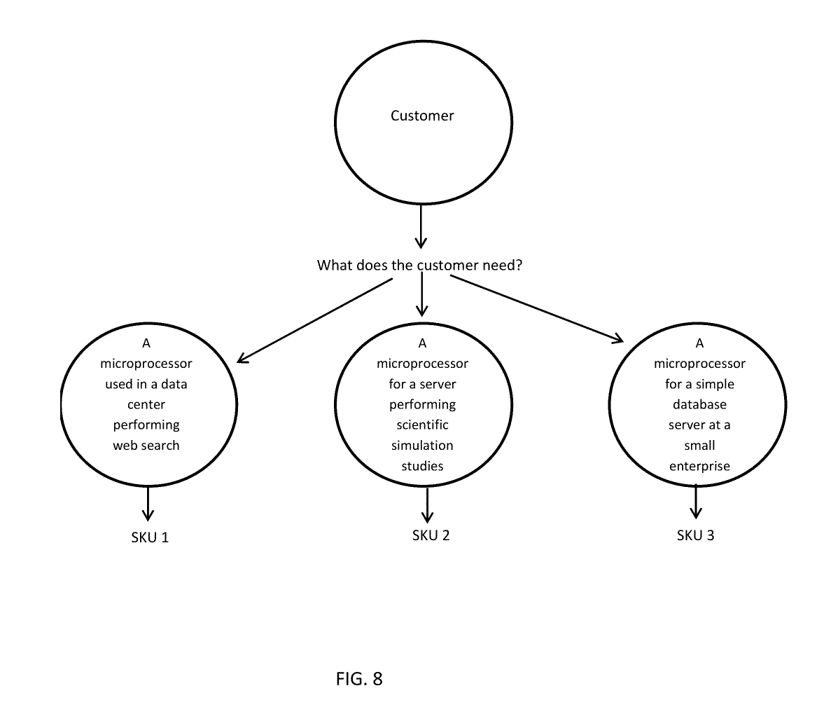

FIG. 8 is a flowchart illustrating a Multinomial Logit choice Model (MLM). The MLM model considers a customer and evaluates the need of the customer. In this example, the customer needs a microprocessor. Depending on what type of microprocessor the customer needs, the MLM model selects a variety of appropriate products. If the customer needs a microprocessor used in a data center performing a web search, the MLM suggests an SKU 1 microprocessor. If the customer needs a microprocessor for a server performing scientific simulation studies, the MLM suggests an SKU 2 microprocessor. If the customer needs a microprocessor for a simple database server at a small enterprise, the MLM suggests an SKU 3 microprocessor.

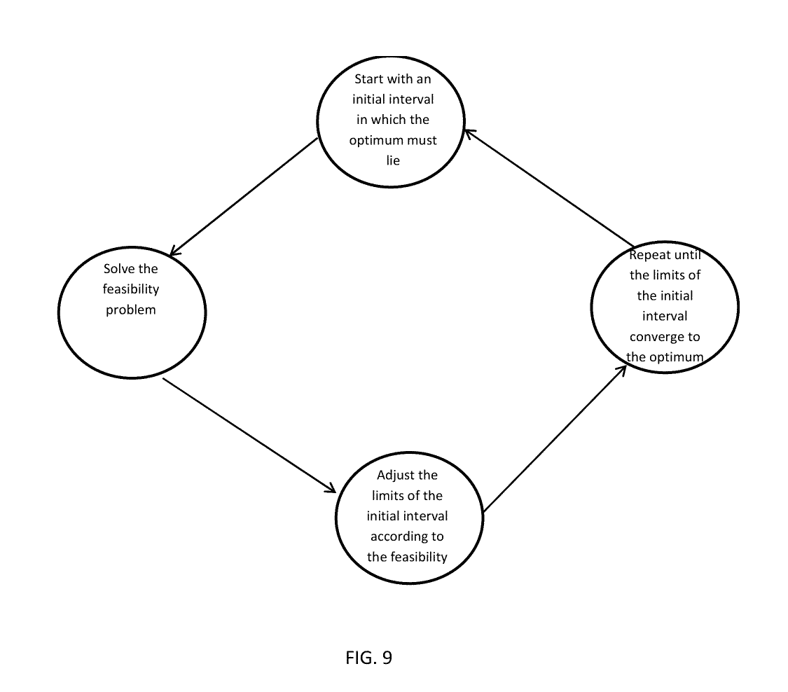

FIG. 9 is a flowchart illustrating an implementation of Algorithm 1 according to aspects of the present disclosure. The algorithm starts by defining an initial interval in which an optimum optimum must lie. The algorithm then solves a feasibility problem and adjust the limits of the initial interval according to the solution of the feasibility problem. The algorithm then repeats the previously described steps until the limits of the initial interval converge to the optimum.

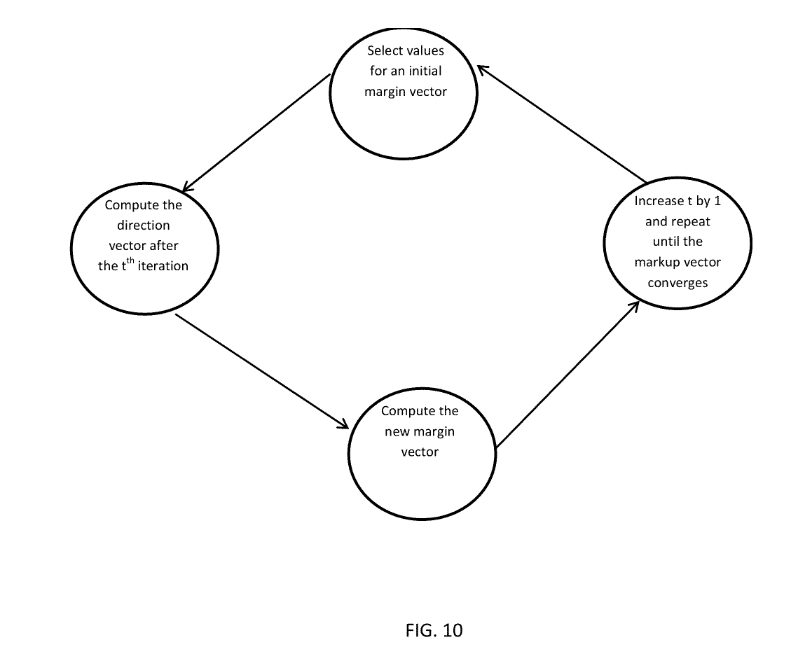

FIG. 10 is a flowchart illustrating an implementation of Algorithm 2 according to aspects of the present disclosure. The algorithm selects values for an initial margin vector then computes the direction vector after the t^{th} iteration. Then, the algorithm computes the new margin vector. The algorithm proceeds to increase t by 1 and repeat until the markup vector converges.

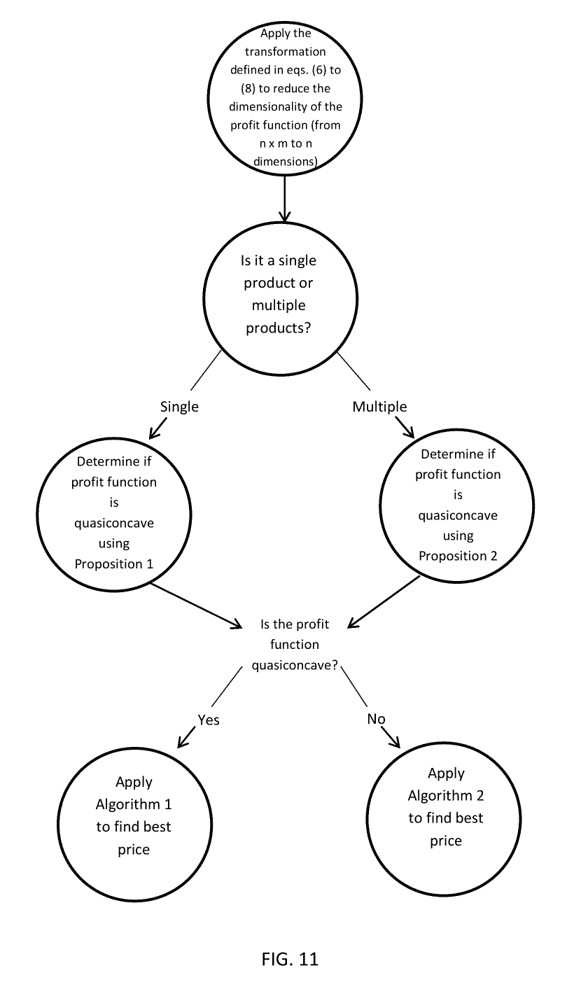

FIG. 11 is a flowchart illustrating an implementation of a pricing solution system, according to aspects of the present disclosure. In this implementation, the system applies the transformation defind in Equations 6 and 8 to reduce the dimensionality of the profit function from n×m to n dimensions. The system then considers whether there exists a single product or multiple products. If there is a single product, Proposition 1 is applied to determine if the product's profit function is quasiconcave. If there exists multiple products, Proposition 2 is applied to determine if the product's profit function is quasiconcave. If the profit function is quasiconcave, for either the single or multiple products, then Algorithm 1 is applied to find the best price for the product. If the profit function is not quasiconcave, then Algorithm 2 is applied to find the best price for the product.

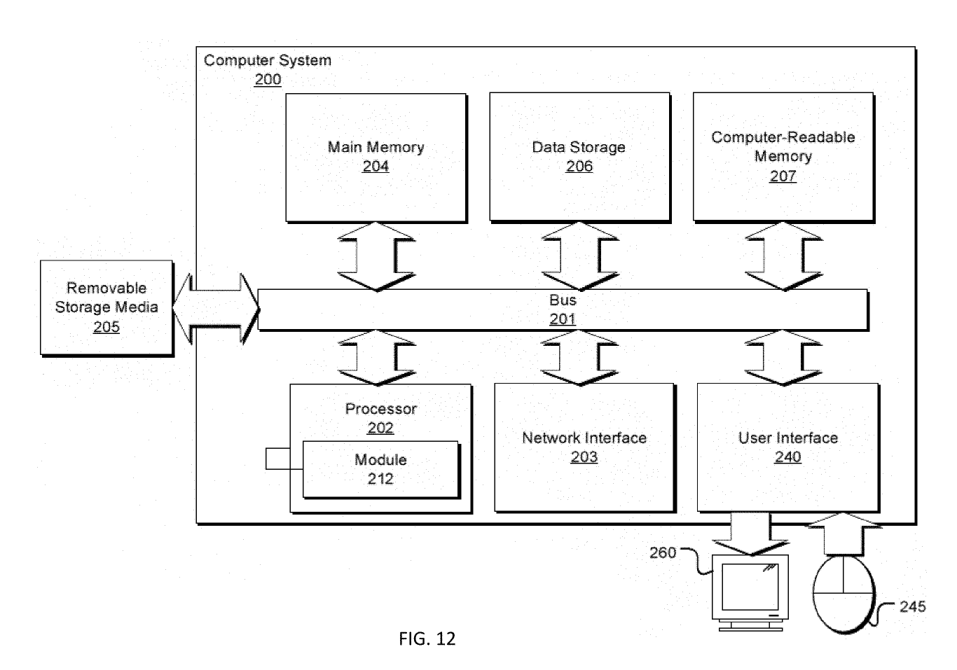

FIG. 12 illustrates an example of a computing and networking environment used to implement various aspects of a pricing solution system as disclosed herein. Example embodiments described herein may be implemented at least in part in electronic circuitry; in computer hardware executing firmware and/or software instructions; and/or in combinations thereof. Example embodiments also may be implemented using a computer program product (e.g., a computer program tangibly or non-transitorily embodied in a machine-readable medium and including instructions for execution by, or to control the operation of, a data processing apparatus, such as, for example, one or more programmable processors or computers). A computer program may be written in any form of programming language, including compiled or interpreted languages, and may be deployed in any form, including as a stand-alone program or as a subroutine or other unit suitable for use in a computing environment. Also, a computer program can be deployed to be executed on one computer, or to be executed on multiple computers at one site or distributed across multiple sites and interconnected by a communication network.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules 212 at different times. Software (such as the application 104) may accordingly configure a processor 202, for example, to constitute a particular hardware-implemented module at one instance of time and to constitute a different hardware-implemented module at a different instance of time.

Hardware-implemented modules 212 may provide information to, and/or receive information from, other hardware-implemented modules 212. Accordingly, the described hardware-implemented modules 212 may be regarded as being communicatively coupled. Where multiple of such hardware-implemented modules 212 exist contemporaneously, communications may be achieved through signal transmission (e.g., over appropriate circuits and buses) that connect the hardware-implemented modules. In embodiments in which multiple hardware-implemented modules 212 are configured or instantiated at different times, communications between such hardware-implemented modules may be achieved, for example, through the storage and retrieval of information in memory structures to which the multiple hardware-implemented modules 212 have access. For example, one hardware-implemented module 212 may perform an operation, and may store the output of that operation in a memory device to which it is communicatively coupled. A further hardware-implemented module 212 may then, at a later time, access the memory device to retrieve and process the stored output. Hardware-implemented modules 212 may also initiate communications with input or output devices.

Referring to FIG. 12, the computing system 200 be a general purpose computing device, although it is contemplated that the computing system 200 may include other computing devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

The computing system 200 may include various hardware components, such as a processing unit 202, a main memory 204 (e.g., a system memory), and a system bus 201 that couples various system components of the computing system 200 to the processing unit 202. The system bus 201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing system 200 may further include a variety of computer-readable media 207 that includes removable/non-removable media and volatile/nonvolatile media, but excludes transitory propagated signals. Computer-readable media 207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing system 200. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 204 includes computer storage media in the form of volatile/nonvolatile memory such as read only memory (ROM) and random access memory (RAM). A basic input/output system (BIOS), containing the basic routines that help to transfer information between elements within the computing system 200 (e.g., during start-up) is typically stored in ROM. RAM typically contains data and/or program modules that are immediately accessible to and/or presently being operated on by processing unit 202. For example, in one embodiment, data storage 206 holds an operating system, application programs, and other program modules and program data.

Data storage 206 may also include other removable/non-removable, volatile/nonvolatile computer storage media. For example, data storage 206 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules and other data for the computing system 200.

A user may enter commands and information through a user interface 240 or other input devices 245 such as a tablet, electronic digitizer, a microphone, keyboard, and/or pointing device, commonly referred to as mouse, trackball or touch pad. Other input devices 245 may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices 245 are often connected to the processing unit 202 through a user interface 240 that is coupled to the system bus 201, but may be connected by other interface and bus structures, such as a parallel port, game port or a universal serial bus (USB). A monitor 260 or other type of display device is also connected to the system bus 201 via user interface 240, such as a video interface. The monitor 260 may also be integrated with a touch-screen panel or the like.

The computing system 200 may operate in a networked or cloud-computing environment using logical connections of a network Interface 203 to one or more remote devices, such as a remote computer. The remote computer may be a personal computer, a server, a router, a network PC, a peer device or other common network node, and typically includes many or all of the elements described above relative to the computing system 200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing system 200 may be connected to a public and/or private network through the network interface 203. In such embodiments, a modem or other means for establishing communications over the network is connected to the system bus 201 via the network interface 203 or other appropriate mechanism. A wireless networking component including an interface and antenna may be coupled through a suitable device such as an access point or peer computer to a network. In a networked environment, program modules depicted relative to the computing system 200, or portions thereof, may be stored in the remote memory storage device.

The pricing solution system 101, which may be implemented at least in part by the computing system 200, presents a technical solution that leverages “big data” that contains detailed customer-specific choice history when facing multiple product or service options and converts this information to concrete executable pricing decisions. This is achieved through a novel computer-based operation procedure that is based on optimization techniques. The pricing solution system 101 adds to the function and capability of a computer-based solution by enabling a company to quantify the effect of any price change on different constituents of its customer population, on different products in its product line, as well as to quantitatively balance the tradeoff between profit and market share. Furthermore, this computer-based system enables a company to pinpoint its current pricing strategy relative to the profit-market share efficient frontier and consequently identify practical improvement opportunities guided by the tools.

The following information provides additional details regarding computations described above.

### Proof of Non-Equal Markup

Lemma 2. Assume bᵢₖ=b for all i, k. Let p*ᵢ be the optimal price for product i. Then in general, p*ᵢ−cᵢ≠p*ⱼ−cⱼ for i≠j.

Proof. Since bᵢₖ=b, the first-order optimality condition becomes

$${p}_{i} - {c}_{i} = \frac{1}{b} + {\sum }_{k} \frac{{w}_{k} {q}_{ik}}{{q}_{i}} {r}_{k} . \qquad ( 10 )$$

Note that

$${\sum }_{k} \frac{{w}_{k} {q}_{ik}}{{q}_{i}} {r}_{k} = \frac{{\sum }_{k} {w}_{k} {q}_{0 k} {A}_{ik} {e}^{- {bp}_{i}} {r}_{k}}{{\sum }_{{k}^{′}} {w}_{{k}^{′}} {q}_{0 {k}^{′}} {A}_{{ik}^{′}} {e}^{- {bp}_{i}}} = {\sum }_{k} \frac{{w}_{k} {q}_{0 k} {A}_{ik}}{{\sum }_{{k}^{′}} {w}_{{k}^{′}} {q}_{0 {k}^{′}} {A}_{{ik}^{′}}} {r}_{k}$$

is a weighted average of rₖ with the weights given by

$$\frac{{w}_{k} {q}_{0 k} {A}_{ik}}{{\sum }_{{k}^{′}} {w}_{{k}^{′}} {q}_{0 {k}^{′}} {A}_{{ik}^{′}}} .$$

Since Aᵢₖ≠A_{ik′} for k≠k′ (otherwise, segments k and k^{J} become degenerated and are considered the same segment), the weights depend on the the product index i.

Assume for contradiction that p*ᵢ−cᵢ=θ for all i. Then

$${r}_{k} ( {p}^{*} ) = {\sum }_{{i}^{′}} ( {p}_{{i}^{′}}^{*} - {c}_{{i}^{′}} ) {q}_{{i}^{′} k} ( {p}^{*} ) = θ {\sum }_{{i}^{′}} {q}_{{i}^{′} k} ( {p}^{*} ) = θ ( 1 - {q}_{0 k} ( {p}^{*} ) ) = θ ( 1 - \frac{1}{1 + {\sum }_{j = 1}^{n} {A}_{jk} {e}^{- {bp}_{j}^{*}}} ) = θ ( 1 - \frac{1}{1 + {e}^{- b θ} {\sum }_{j = 1}^{n} {A}_{jk} {e}^{- {bc}_{j}}} )$$

whose value depends on the segment index k, thus in general rₖ's are not equal across segments. Since the right side of equation (10) is a weighted average of the vector (r₁, r₂, . . . , rₘ) with nonequal values and the weights depend on the product index i, this weighted average is a value that depends on i. This contradicts the assumption that p*ᵢ−cᵢ=θ for all i.

### A.2 Proof of Lemma 1

Proof. Since bᵢₖ=b, the first-order optimality condition becomes

$${p}_{i} - {c}_{i} = \frac{1}{b} + \frac{{w}_{A} {q}_{iA}}{{q}_{i}} {r}_{A} + \frac{{w}_{B} {q}_{iB}}{{q}_{i}} {r}_{B} = \frac{1}{b} + {r}_{B} + \frac{{w}_{A} {q}_{iA}}{{q}_{i}} ( {r}_{A} - {r}_{B} ) .$$

Thus p*ᵢ−cᵢ≥p*ⱼ−cⱼ if and only if

$$( \frac{{w}_{A} {q}_{iA}}{{q}_{i}} - \frac{{w}_{A} {q}_{jA}}{{q}_{j}} ) ( {r}_{A} - {r}_{B} ) \geq 0.$$

It is easy to verify that

$$( \frac{{w}_{A} {q}_{iA}}{{q}_{i}} - \frac{{w}_{A} {q}_{jA}}{{q}_{j}} )$$

has the same sign as [(a_{iA}−a_{iB})−(a_{jA}−a_{jB})].

(Note that

$$\frac{{w}_{A} {q}_{iA}}{{q}_{i}} \geq \frac{{w}_{A} {q}_{jA}}{{q}_{j}} ⇔ \frac{{q}_{i}}{{w}_{A} {q}_{iA}} \leq \frac{{q}_{j}}{{w}_{A} {q}_{jA}} ⇔ \frac{{w}_{A} {q}_{iA} + {w}_{B} {q}_{iB}}{{w}_{A} {q}_{iA}} \leq \frac{{w}_{A} {q}_{jA} + {w}_{B} {q}_{jB}}{{w}_{A} {q}_{jA}} ⇔ \frac{{q}_{iB}}{{q}_{iA}} \leq \frac{{q}_{jB}}{{q}_{jA}} ⇔ \frac{{q}_{iB}}{{q}_{jB}} \leq \frac{{q}_{iA}}{{q}_{jA}} ⇔ \frac{{e}^{{a}_{iB} - {b}_{i} {p}_{i}}}{{e}^{{a}_{jB - {b}_{j} {p}_{j}}}} \leq \frac{{e}^{{a}_{iA} - {b}_{i} {p}_{i}}}{{e}^{{a}_{jA - {b}_{j} {p}_{j}}}} ⇔ {a}_{iA} - {a}_{iB} \geq {a}_{jA} - {a}_{jB} . )$$

Therefore, p*ᵢ−cᵢ≥p*ⱼ−cⱼ if and only if [(a_{iA}−a_{iB})−(a_{jA}−a_{jB})](r_{A}−r_{B})≥0 for i≠j.

A.3 an Example with Preference-Value-Inconsistent Optimal Prices

Consider a two-product (products 1 and 2) two-segment (segments A and B) example with w_{A}=w_{B}=0.5, bᵢₖ=1, cᵢ=0, a_{1A}=6, a_{2A}=5, a_{1B}=3, a_{2B}=1. Product 1 has higher price-independent utility values than product 2 for both segments of customers. The optimal prices for product 1 and product 2 are p₁=4.011, p₂=4.387, which is a sequence that is the opposite of the preference value sequence.

### A.4 Proof of Proposition 1

Proof. To simplify presentation, we suppress the product subscript in our notation (e.g., qₖ in place of qᵢₖ). Note that the purchase probability of the product by a segment k customer is q^{k}=qₖ. Accordingly,

$${f}_{k} ( {q}_{1} ) = \frac{{A}_{k} ( \frac{{q}_{1}}{{A}_{1} ( 1 - {q}_{1} )} )}{1 + {A}_{k} ( \frac{{q}_{1}}{{A}_{1} ( 1 - {q}_{1} )} )} ,$$

$${g}_{k} ( {q}_{k} ) = \frac{1}{b} log ( \frac{{A}_{k} ( 1 - {q}_{k} )}{{q}_{k}} ) ,$$

and the profit contribution from a segment k customer as a function of q₁ simplifies to

$${\hat{R}}_{k} ( {q}_{1} ) = ( {g}_{k} ( {f}_{k} ( {q}_{1} ) ) - c ) {f}_{k} ( {q}_{1} ) = ( \frac{log {A}_{k} - log ( {λ}_{k} {q}_{1} ) + log ( 1 - {q}_{1} ) - bc}{b} ) \frac{{λ}_{k} {q}_{1}}{1 - {q}_{1} + {λ}_{k} {q}_{1}}$$

where λk=Aₖ/A₁. We can derive that

$$- bz \frac{{\partial }^{2} \hat{{R}_{k}}}{\partial {q}_{1}^{2}} = \frac{{λ}_{k}^{2}}{x} + \frac{2 {λ}_{k}}{y} + \frac{x}{{y}^{2}} + 2 {L ( {λ}_{k} - 1 )}^{2} ( \frac{1}{2} - \frac{x}{{z}^{2}} ) + \frac{2}{z} ( {λ}_{k} - 1 ) ( L - {λ}_{k} ) - \frac{2 x}{yz} ( {λ}_{k} - 1 ) ,$$

where x:=λₖq₁; y:=q₀₁, z:=λₖq₁+q₀₁, and L:=log Aₖ−log (λₖq₁)+log q₀₁−bc. Assume without loss of generality that λₖ≥1. From

$$\frac{{max}_{k} {A}_{k}}{{min}_{k} {A}_{k}} \leq 2 ,$$

we have λₖ≤2, equivalently, λₖ≥2(λₖ−1). Therefore,

$$- bz \frac{{\partial }^{2} {R}_{k}}{\partial {q}_{1}^{2}} \geq \frac{{λ}_{k}^{2}}{x} + \frac{2 {λ}_{k}}{y} + \frac{x}{{y}^{2}} + \frac{2}{z} {L ( {λ}_{k} - 1 )}^{2} - \frac{2 x}{{z}^{2}} {L ( {λ}_{k} - 1 )}^{2} - \frac{2}{z} {λ}_{k} ( {λ}_{k} - 1 ) - \frac{2 x}{yz} ( {λ}_{k} - 1 ) \geq \frac{{λ}_{k}^{2}}{x} + \frac{2 {λ}_{k}}{y} + \frac{x}{{y}^{2}} - \frac{2}{z} {λ}_{k} ( {λ}_{k} - 1 ) - \frac{2 x}{yz} ( {λ}_{k} - 1 ) = {λ}_{k} [ \frac{{λ}_{k}}{x} - \frac{2}{z} ( {λ}_{k} - 1 ) ] + \frac{2}{y} [ {λ}_{k} - \frac{x}{z} ( {λ}_{k} - 1 ) ] + \frac{x}{{y}^{2}} \geq \frac{x}{{y}^{2}} \geq 0$$

where the first inequality holds due to L>0 (i.e., L=b(p−c)>0), the second inequality holds because

$$\frac{x}{z} \leq 1 ,$$

and the third inequality holds due to λₖ≥2(λₖ−1) and x≤z. Therefore, \hat{R}ₖ is concave on Ω₁. The weighted sum of concave functions is concave, and thus \hat{Π} is concave on Ω₁.

### A.5 Proof of Proposition 2

Proof. From (7), to establish the concavity of \hat{Π}(q¹), it suffices to show concavity of \hat{R}ₖ(q¹). Recall that fₖ(q¹) is the vector of product purchase probabilities for segment k as a function of vector q1. Let fᵢₖ(q¹) denote the ith element in fₖ(q¹). Then the profit contribution of product i in segment k can be written as \hat{R}ᵢₖ(q¹)=(gᵢₖ(fₖ(q¹))−cᵢ)fᵢₖ(q¹) and the segment-k profit as

$${\hat{R}}_{k} ( {q}^{1} ) = {\sum }_{i = 1}^{n} {\hat{R}}_{ik} ( {q}^{1} ) .$$

From (4) and (6),

$${b}_{i} {\hat{R}}_{ik} ( {q}^{1} ) = \frac{{A}_{ik} ( \frac{{q}_{i 1}}{{A}_{i 1} {q}_{01}} )}{1 + {\sum }_{j = 1}^{n} {A}_{jk} ( \frac{{q}_{j 1}}{{A}_{j 1} {q}_{01}} )} [ log ( \frac{{A}_{i 1} {q}_{01}}{{q}_{i 1}} ) - {b}_{i} {c}_{i} ] = \frac{\frac{{A}_{i k} {q}_{i 1}}{{A}_{i 1} {q}_{01}}}{1 + {\sum }_{i = 1}^{n} ( \frac{{A}_{jk} {q}_{j 1}}{{A}_{j 1} {q}_{01}} )} [ log {A}_{ik} - log ( \frac{{A}_{i k} {q}_{i 1}}{{A}_{i 1} {q}_{01}} ) - {b}_{i} {c}_{i} ] = \frac{{λ}_{ik} {q}_{i 1}}{{q}_{01} + {\sum }_{j = 1}^{n} ( {λ}_{jk} {q}_{j 1} )} [ log {A}_{ik} - log ( {A}_{i k} {q}_{i 1} ) + log {q}_{01} - {b}_{i} {c}_{i} ]$$

where λᵢₖ=Aᵢₖ/Aᵢ₁ and q₀₁=1−Σ_{i′=1}ⁿq_{i′1}. For a given segment k, define Z (q¹):=bᵢ\hat{R}ᵢₖ(q¹). We can derive that

$$\frac{{\partial }^{2} {Z}_{i}}{\partial {q}_{l 1}^{2}} = - \frac{{x}_{i}}{{y}^{2} z} + \frac{2 {x}_{i}}{{z}^{3}} {( {λ}_{lk} - 1 )}^{2} {L}_{i} + \frac{2 {x}_{i}}{{yz}^{2}} ( {λ}_{lk} - 1 ) l \neq i$$

$$\frac{{\partial }^{2} {Z}_{i}}{\partial {q}_{i 1}^{2}} = - \frac{{x}_{i}}{{y}^{2} z} + \frac{2 {x}_{i}}{{z}^{3}} {( {λ}_{ik} - 1 )}^{2} {L}_{i} + \frac{2 {x}_{i}}{{yz}^{2}} ( {λ}_{lk} - 1 ) - \frac{{λ}_{ik}^{2}}{{x}_{i} z} - \frac{2 {λ}_{ik}}{yz} - \frac{2 {λ}_{ik} ( {λ}_{ik} - 1 )}{{z}^{2}} ( {L}_{i} - 1 )$$

$$\frac{{\partial }^{2} {Z}_{i}}{\partial {q}_{l 1} \partial {q}_{j 1}} = - \frac{{x}_{i}}{{y}^{2} z} + \frac{2 {x}_{i}}{{z}^{3}} ( {λ}_{lk} - 1 ) ( {λ}_{jk} - 1 ) {L}_{i} + \frac{{x}_{i}}{{yz}^{2}} ( {λ}_{lk} - 1 + {λ}_{jk} - 1 ) l , j \neq i \\ \frac{{\partial }^{2} {Z}_{i}}{\partial {q}_{i 1} \partial {q}_{l 1}} = - \frac{{x}_{i}}{{y}^{2} z} + \frac{2 {x}_{i}}{{z}^{3}} ( {λ}_{ik} - 1 ) ( {λ}_{lk} - 1 ) {L}_{i} + \frac{{x}_{i}}{{yz}^{2}} ( {λ}_{ik} - 1 + {λ}_{lk} - 1 ) - \frac{{λ}_{ik}}{yz} - \frac{1}{{z}^{2}} {λ}_{ik} ( {λ}_{lk} - 1 ) ( {L}_{i} - 1 ) l \neq i ,$$

where xᵢ:=λᵢₖqᵢ₁, y:=q₀₁, z:=q₀₁+Σⱼλⱼₖqⱼ₁, and Lᵢ:=log Aᵢₖ−log xᵢ+log y−bᵢcᵢ=bᵢ(pᵢ−cᵢ). The Hessian of

$${\hat{R}}_{k} ( {q}^{1} ) = {\sum }_{i = 1}^{n} {\hat{R}}_{ik} ( {q}^{1} ) = {\sum }_{i = 1}^{n} {Z}_{i} ( {q}^{1} ) / {b}_{i}$$

is

$$H ( {q}^{1} ) = [ \begin{matrix}\begin{matrix}\begin{matrix}\frac{{\partial }^{2} {\sum }_{i = 1}^{n} {Z}_{i} / {b}_{i}}{\partial {q}_{11}^{2}} , \frac{{\partial }^{2} {\sum }_{i = 1}^{n} {Z}_{i} / {b}_{i}}{\partial {q}_{11} \partial {q}_{21}} , … , \frac{{\partial }^{2} {\sum }_{i = 1}^{n} {Z}_{i} / {b}_{i}}{\partial {q}_{11} \partial {q}_{n 1}} \\ \frac{{\partial }^{2} {\sum }_{i = 1}^{n} {Z}_{i} / {b}_{i}}{\partial {q}_{21} \partial {q}_{11}} , \frac{{\partial }^{2} {\sum }_{i = 1}^{n} {Z}_{i} / {b}_{i}}{\partial {q}_{21}^{2}} , … , \frac{{\partial }^{2} {\sum }_{i = 1}^{n} {Z}_{i} / {b}_{i}}{\partial {q}_{21} \partial {q}_{n 1}}\end{matrix} \\ …\end{matrix} \\ \frac{{\partial }^{2} {\sum }_{i = 1}^{n} {Z}_{i} / {b}_{i}}{\partial {q}_{n 1} \partial {q}_{11}} , \frac{{\partial }^{2} {\sum }_{i = 1}^{n} {Z}_{i} / {b}_{i}}{\partial {q}_{n 1} \partial {q}_{21}} , … , \frac{{\partial }^{2} {\sum }_{i = 1}^{n} {Z}_{i} / {b}_{i}}{\partial {q}_{n 1} \partial {q}_{n 1}}\end{matrix} ] .$$

The function \hat{R}ₖ(q¹) is concave on Ω₁ if and only if θ^{T}Hθ<0 for any nonzero vector θ^{T}=(θ₁, θ₂, . . . , θₙ) and any q¹∈Ω₁. Note that

$$\begin{matrix}{θ}^{T} H θ = {\sum }_{l = 1}^{n} {θ}_{l}^{2} \frac{{\partial }^{2} {\sum }_{i = 1}^{n} {Z}_{i} / {b}_{i}}{\partial {q}_{l 1}^{2}} + {\sum }_{l = 1}^{n} {\sum }_{j \neq l}^{n} {θ}_{l} {θ}_{j} \frac{{\partial }^{2} {\sum }_{i = 1}^{n} {Z}_{i} / {b}_{i}}{\partial {q}_{l 1} \partial {q}_{j 1}} \\ = {- \sum }_{i} \frac{1}{{b}_{i} {x}_{i} z} {( {θ}_{i} {λ}_{ik} + \frac{{x}_{i}}{y} {\sum }_{l} {θ}_{l} )}^{2} - \\ {\sum }_{i} \frac{{L}_{i} - 1}{{b}_{i} {z}^{2}} 2 {θ}_{i} {λ}_{ik} [ {\sum }_{l} {θ}_{l} ( {λ}_{lk} - 1 ) ] + \\ {\sum }_{i} {\frac{2 {x}_{i} {L}_{i}}{{b}_{i} {z}^{3}} [ {\sum }_{i} {θ}_{l} ( {λ}_{lk} - 1 ) ]}^{2} + \\ {\sum }_{i} \frac{2 {x}_{i}}{{b}_{i} {yz}^{2}} [ {\sum }_{l} {θ}_{l}^{2} ( {λ}_{lk} - 1 ) + {\sum }_{l} {\sum }_{j \neq e} {θ}_{l} {θ}_{j} ( {λ}_{lk} - 1 + {λ}_{jk} - 1 ) ] .\end{matrix}$$

Define G(λ):=θ^{T}Hθ where λ=[λᵢₖ] for i=1, . . . , n and k=1, . . . , m (i.e., λ is an n×m matrix). The function G has a strict negative value at λ=1 (because it is not possible to find a nonzero vector θ such that

$${θ}_{i} {λ}_{ik} + \frac{xi}{y} {\sum }_{l} {θ}_{l} = 0$$

for all G is continuous in λ. So there must exist a rectangle region near λ=1 in which the values of G stay negative.

### A.6 Proof of Proposition 3

Proof. The concavity of Π̅(q¹) and Π(q^{m}) follows from Lemma 2 in Li and Huh (2011). From (2) and Aᵢ₁≤Aᵢₖ≤Aᵢₘ, q₀₁<q₀ₖ≥q₀ₘ. From (4),

$${p}_{i} = \frac{1}{{b}_{i}} [ log {A}_{i 1} - log {q}_{i 1} + log ( 1 - {\sum }_{j} {q}_{j 1} ) ] . \qquad ( 11 )$$

Since

$${q}_{ik} = {A}_{ik} {q}_{0 k} \frac{{q}_{i 1}}{{A}_{i 1} {q}_{01}} , \\ \begin{matrix}\hat{\prod } ( {q}^{1} ) = {\sum }_{i} ( {p}_{i} ( {q}^{1} ) - {c}_{i} ) {\sum }_{k} {w}_{k} {q}_{ik} = \\ {\sum }_{i} ( {q}_{i 1} ( {q}^{1} ) - {c}_{i} ) {\sum }_{k} {w}_{k} {A}_{ik} {q}_{0 k} ( \frac{{q}_{i 1}}{{A}_{i 1} {q}_{01}} ) \\ = {\sum }_{i} \frac{{q}_{i 1}}{{b}_{i}} [ log {A}_{i 1} - log {q}_{i 1} + log ( 1 - {\sum }_{j} {q}_{j 1} ) - {b}_{i} {c}_{i} ] {\sum }_{k} {w}_{k} ( \frac{{A}_{ik} {q}_{0 k}}{{A}_{i 1} {q}_{01}} ) \\ \leq {\sum }_{i} \frac{{q}_{i 1}}{{b}_{i}} [ log {A}_{i 1} - log {q}_{i 1} + log ( 1 - {\sum }_{j} {q}_{j 1} ) - {b}_{i} {c}_{i} ] {\sum }_{k} {w}_{k} ( \frac{{A}_{ik}}{{A}_{i 1}} ) \\ = \overline{\prod } ( {q}^{1} ) .\end{matrix}$$

Similarly it can be shown that \tilde{Π}(q^{m})≥Π(q^{m}).

A.7 Corollary 1 (Upper Bounds of Π̅(q¹) and Π(q^{m}))

Corollary 1. Let q̅¹̅=argmax_{q}_{¹}Π̅(q¹) and p̅¹̅ be the corresponding price vector. In addition, let q̅^̅{̅m̅}̅=argmax_{q}_{^{m}}Π̅(q^{m}) and p̅^̅{̅m̅}̅ be the corresponding price vector.

(i) The maximum of Π̅(q¹) is given by θ̅ where θ̅ is the unique solution to the single-variable equation

$$\overline{θ} = {\sum }_{i} ( \frac{{e}^{{a}_{i 1} - {b}_{i} {c}_{i} - 1 - \frac{{b}_{i} \overline{θ}}{{\sum }_{k} {w}_{k} {A}_{ik} / {A}_{i 1}}}}{{b}_{i}} {\sum }_{k} {w}_{k} {A}_{ik} / {A}_{i 1} ) .$$

(ii) The maximum of Π(q^{m}) is given by θ where θ is the unique solution to the single-variable equation

$$\underline{θ} = {\sum }_{i} ( \frac{{e}^{{a}_{im} - {b}_{i} {c}_{i} - 1 - \frac{{b}_{i} \underline{θ}}{{\sum }_{k} {w}_{k} {A}_{ik} / {A}_{i m}}}}{{b}_{i}} {\sum }_{k} {w}_{k} {A}_{ik} / {A}_{i m} ) .$$

Proof. Since Π̅(q¹) is concave in q¹, we take the first order derivative with respect to qⱼ₁, and set it to zero to obtain the first-order condition

$${p}_{j} - {c}_{j} = \frac{1}{{b}_{j}} + \frac{\overline{θ}}{{\sum }_{k} {w}_{k} {A}_{jk} / {A}_{j 1}} , \qquad ( 12 )$$

where

$$\overline{θ} = {\sum }_{i} \frac{{q}_{i 1} / {q}_{01}}{{b}_{i}} {\sum }_{k} {w}_{k} {A}_{ik} / {A}_{i 1} . \qquad ( 13 )$$

### Thus

$${q}_{i 1} / {q}_{01} = {e}^{{a}_{i 1} - {b}_{i} {p}_{i}} = {e}^{{a}_{i 1} - {b}_{i} {c}_{i} - 1 - {b}_{i}} \frac{\overline{θ}}{{\sum }_{k} {w}_{k} {A}_{ik} / {A}_{i 1}} . \qquad ( 14 )$$

From (13) and (14), we have

$$\overline{θ} = {\sum }_{i} \frac{{e}^{{a}_{i 1} - {b}_{i} {c}_{i} - 1 - \frac{{b}_{i} \overline{θ}}{{\sum }_{k} {w}_{k} {A}_{ik} / {A}_{i 1}}}}{{b}_{i}} {\sum }_{k} {w}_{k} {A}_{ik} / {A}_{i 1} .$$

Therefore, the profit Π̅ can be rewritten as

$$\begin{matrix}\overline{\prod } = {\sum }_{i} ( {p}_{i} - {c}_{i} ) {q}_{i 1} {\sum }_{k} {w}_{k} {A}_{ik} / {A}_{i 1} \\ = {\sum }_{i} ( \frac{1}{{b}_{i}} + \frac{\overline{θ}}{{\sum }_{k} {w}_{k} {A}_{ik} / {A}_{i 1}} ) {q}_{i 1} {\sum }_{k} {w}_{k} {A}_{ik} / {A}_{i 1} \\ = ( {\sum }_{i} \frac{{q}_{i 1} / {q}_{01}}{{b}_{i}} {\sum }_{k} {w}_{k} {A}_{ik} / {A}_{i 1} ) {q}_{01} + \overline{θ} {\sum }_{i} {q}_{i 1} \\ = \overline{θ} {q}_{01} + \overline{θ} {\sum }_{i} {q}_{i 1} = \overline{θ} ,\end{matrix}$$

where the second equality follows from (12) and the fourth equality follows from (13). This proves (i). The proof of (ii) follows a similar argument.

### A.8 Proof of Proposition 4

Proof. Note that f₁(q¹)=q¹. Thus \hat{R}₁(q¹)=R₁(f₁(q¹))=R₁(q¹) is a profit function based on MNL demand which, as noted above, is concave.

What remains is to show that \hat{R}ₖ(q¹) is quasiconcave for k≥2. Without loss of gen-erality, we set k=2. Let us outline the main steps of our proof. We first show that Ω₄:={f₂(q¹)|q¹∈Ω₁} is a convex set by decomposing function f₂ into a composition of more elementary functions, and show that each of these functions preserves convexity. We then explain why the convexity of Ω₁ implies that superlevel set S_{α}(R₂, Ω₁)={q²∈Ω₄|R₂(q²)≥α} is convex. Finally, we show that the inverse image S_{α}(R₂, Ω₄) under function f₂ is convex (using a similar decomposition approach), which implies that superlevel set S_{α}(\hat{R}₂, Ω₁)={q¹∈Ω₁|\hat{R}₂(q¹)≥α} is convex, thereby proving that \hat{R}₂ is quasicon-cave. Our proof will rely on the following definitions, remark, and property.

Definition 1. Function f: Rⁿ→R is quasiconcave if its domain is convex and its su-perlevel sets S_{α}(f, dom f)={x∈dom f|f(x)≥α} are convex for all ∈R (Boyd and Vandenberghe 2004, p. 95).

Definition 2. Let A∈R^{n×m}, b∈Rⁿ, c∈R^{m}, d∈R. Function f: R^{m}→^{R}n with f(x)=(Ax+b)/(c^{T}x+d) defined on dom f={x|c^{T}x+d>0} is a linear-fractional function (Boyd and Vandenberghe 2004, p. 41).

Let C ∈dom f be a convex set. Note that S_{α}(f, C)={x∈C|f(x)≥α}=C∩S_{α} (f, dom f). The following remark follows from the fact that the intersection of two convex sets is a convex set.

Remark 1. Let C∈dom f be a convex set. If f is quasiconcave on dom f, then f is quasiconcave on.

Property 1. Let f be a linear-fractional function and let C∈dom f be a convex set. Then image D={f(x)|x∈C} is a convex set. Furthermore, the inverse image of a convex set under a linear-fractional function is also convex, i.e., {f⁻¹(y)|y∈D} is convex if D is convex (Boyd and Vandenberghe 2004, p. 42).

Note that

$${Ω}_{1 =} \{ {q}^{1} \vert {\sum }_{i = 1}^{n} {q}_{i 1} \leq 1 , {q}_{i 1} \geq 0 , {g}_{i 1} ( {q}^{1} ) \geq {c}_{i} {∀}_{i} \} = {dom}^{{\hat{R}}_{k}}$$

is a convex set. Consider the following function F₁ that maps q¹ ∈Ω₁ to x∈Rⁿ:

$$x = {F}_{1} ( {q}^{1} ) = ( \frac{{q}_{11} / {A}_{11}}{1 - {\sum }_{l = 1}^{n} {q}_{l 1}} , … , \frac{{q}_{n 1} / {A}_{n 1}}{1 - {\sum }_{l = 1}^{n} {q}_{l 1}} ) .$$

Function F₁ is a linear-fractional function (see Definition 2), and thus it follows from Property 1 that the image of Ω₁ under F₁, Ω₂={F₁(q¹)|q¹∈Ω₁}, is a convex set.

Next consider the following function F₂ that maps x∈Ω₂ to y∈Rⁿ:

y=F₂(x)=(A₁₂x₁^{b}^{₁₂}^{/b}^{₁₁}, . . . ,Aₙ₂xₙ^{b}^{ₙ₂}^{/b}^{ₙ₁}).

The image of Ω₂ under F₂ is Ω₃={F₂(x)|x∈Ω₂}={A₁₂x₁^{b}^{₁₂}^{/b}^{₁₁}, . . . , Aₙ₂xₙ^{b}^{ₙ₂}^{/b}^{ₙ₁}|x∈Ω₂}. We next show that Ω₃ is a convex set. Let x⁽¹⁾ and x⁽²⁾ denote two distinct points in Ω₂, so that F₂ (x⁽¹⁾) and F₂ (x⁽²⁾) are two points in Ω₃. Note that Ω₃ is convex if and only if αF₂(x⁽¹⁾)+(1−α)F₂(x⁽²⁾)∈Ω₃ for all α∈[0, 1] and all x⁽¹⁾ and x⁽²⁾ in Ω₂, i.e., for any α∈[0, 1] and any x⁽¹⁾ and x⁽²⁾ in Ω₂, we require αF₂(x⁽¹⁾)+(1−α)F₂(x⁽²⁾)=F₂(x⁽³⁾) for some x⁽³⁾∈Ω₂. We use a subscript on function F₂ to denote the functional element in vector F₂(x), i.e., F₂ᵢ(xᵢ)=Aᵢ₂xᵢ^{b}^{₁₂}^{/b}^{₁₁}. Thus, α F₂ᵢ(xᵢ⁽¹⁾)+(1−α)F₂ᵢ(xᵢ⁽²⁾)=αAᵢ₂(xᵢ⁽¹⁾)^{b}^{ᵢ₂}^{/b}^{ᵢ₁}+(1−α)Aᵢ₂(xᵢ⁽²⁾)^{b}^{ᵢ₂}^{/b}^{ᵢ₁}.

Assume without loss of generality that xᵢ⁽¹⁾≤xᵢ⁽²⁾. Then, because F₂ᵢ(xᵢ) is strictly increasing in xᵢ, Aᵢ₂(xᵢ⁽¹⁾)^{b}^{ᵢ₂}^{/b}^{ᵢ₁}≤αAᵢ₂(xᵢ⁽¹⁾)^{b}^{ᵢ₂}^{/b}^{ᵢ₁}+(1−α)Aᵢ₂(xᵢ⁽²⁾)^{b}^{ᵢ₂}^{/b}^{ᵢ₁}≤Aᵢ₂(xᵢ⁽²⁾)^{b}^{ᵢ₂}^{/b}^{ᵢ₁} and there exists xᵢ⁽³⁾∈[xᵢ⁽¹⁾, xᵢ⁽²⁾] such that αAᵢ₂(xᵢ⁽¹⁾)^{b}^{ᵢ₂}^{/b}^{ᵢ₁}+(1−α)Aᵢ₂(xᵢ⁽²⁾)^{b}^{ᵢ₂}^{/b}^{ᵢ₁}=Aᵢ₂(xᵢ⁽³⁾)^{b}^{ᵢ₂}^{/b}^{ᵢ₁}, and equivalently, there exists θᵢ∈[0, 1] that satisfies αAᵢ₂(xᵢ⁽¹⁾)^{b}^{ᵢ₂}^{/b}^{ᵢ₁}+(1−α)Aᵢ₂(xᵢ⁽²⁾)^{b}^{ᵢ₂}^{/b}^{ᵢ₁}=Aᵢ₂(θ, xᵢ⁽¹⁾+(1−θᵢ)xᵢ⁽²⁾)^{b}^{ᵢ₂}^{/b}^{ᵢ₁}=Aᵢ₃(xᵢ⁽³⁾)^{b}^{ᵢ₂}^{/b}^{ᵢ₁}.

Of course, if bᵢ₂/bᵢ₁=1; then θᵢ=α. Combining the above, we have the following identity:

αF₂ᵢ(xᵢ⁽¹⁾)+(1−α)F₂ᵢ(xᵢ⁽²⁾)=F₂ᵢ(θᵢxᵢ⁽¹⁾+(1−θᵢ)xᵢ⁽²⁾) for some θᵢ∈[0, 1] and all i. Therefore, αF₂(x⁽¹⁾)+(1−α)F₂(x⁽²⁾)∈Ω₃ if and only if

x⁽³⁾:=(θ₁x₁⁽¹⁾+(1−θ₁)x₁⁽²⁾, . . . ,θₙxₙ⁽¹⁾+(1−θₙ)xₙ⁽²⁾)∈Ω₂. (15)

To determine whether (15) holds, we need to characterize set Ω₂. Note that

$$x = {F}_{1} ( {q}^{1} ) = ( \frac{{q}_{11}}{{A}_{11} {q}_{01}} , … , \frac{{q}_{n 1}}{{A}_{n 1} {q}_{01}} ) .$$

For pair with i, j∈{₁, . . . , n} with i≠j, let

$$Δ = {\sum }_{l = 1}^{n} {q}_{l 1} - {q}_{i 1} - {q}_{j 1} .$$

We keep q₀₁ and Δ fixed, and examine the (xᵢ, xⱼ) curve as qᵢ₁ varies over its feasible range [0, 1−q₀₁−Δ]. Note that qⱼ₁=1−q₀₁−Δ−qᵢ₁, and thus

$${x}_{j} = \frac{1 - {q}_{01} - Δ - {q}_{i 1}}{{A}_{j 1} {q}_{01}} = \frac{1 - {q}_{01} - Δ}{{A}_{j 1} {q}_{01}} - \frac{{A}_{i 1}}{{A}_{j 1}} ( \frac{{q}_{i 1}}{{A}_{i 1} {q}_{01}} ) = \frac{1 - {q}_{01} - Δ}{{A}_{j 1} {q}_{01}} - \frac{{A}_{i 1}}{{A}_{j 1}} {x}_{i}$$

for

$${x}_{i} ∈ [ 0 , \frac{1 - {q}_{01} - Δ}{{A}_{i 1} {q}_{01} } ]$$

It is apparent that the function xⱼ(xᵢ) is a line with slope−Aᵢ₁/Aⱼ₁ connecting points

$$( 0 , \frac{t - {q}_{01} - Δ}{{A}_{j 1} {q}_{01}} ) and ( \frac{1 - {q}_{01} - Δ}{{A}_{i 1} {q}_{01}} , 0 ) .$$

By letting δ:=q₀₁+Δ vary over interval [0, 1] and q₀₁ vary over interval [0, δ−Δ], we see that our xⱼ(xᵢ) curves cover the entire positive orthant in two dimensions. This holds for all i, j ∈{1, . . . , n} with i≠j, and thus Ω₂ is the positive orthant in n dimensions. Therefore, (15) holds if x⁽³⁾ is in the positive orthant. This is clearly the case because θᵢ∈[0, 1] for all i and both x⁽¹⁾∈Ω₂ and x⁽²⁾ ∈Ω₂ are in the positive orthant. By the above arguments, we have shown that αF₂(x⁽¹⁾)+(1−α)F₂(x⁽²⁾)∈Ω₃, and thus Ω₃ is a convex set.

Finally, consider the following function F₃ that maps y∈Ω₃ to z ∈Rₙ:

$$z = {F}_{3} ( y ) = ( \frac{{y}_{1}}{1 + {\sum }_{j = 1}^{n} {y}_{i}} , … , \frac{{y}_{n}}{1 + {\sum }_{j = 1}^{n} {y}_{i}} ) .$$

F₃ is a linear-fractional function (see Definition 2), and thus it follows from Property 1 that the image of Ω₃ under F₃, Ω₄={F₃(y)|y∈Ω₃}, is a convex set.

Now, to conclude that \hat{R}₂ is quasiconcave, we need to show that all of its superlevel sets are convex. Note that \hat{R}₂(q¹)=R₂(F₃(F₂(F₁(q¹))))=R₂(f₂(q¹))=R₂(f₂(q¹)). We see that \hat{R}₂(q¹) is obtained by evaluating R₂ at a point in convex set Ω₄. Because the segment profit function R₂ (q²) is concave (and quasiconcave) on

$$dom {R}_{2} = \{ {q}_{i 2} \vert {\sum }_{i = 1}^{n} {q}_{i 2} \leq 1 , {q}_{i 2} \geq 0 {∀}_{i} \}$$

and Ω₄⊂dom R₂ is convex set, we know from Remark 1 that R₂ is quasiconcave on Ω₄, and thus S_{α}(R₂, Ω₄)={q²∈Ω₄|R₂(q²)≥α} is a convex set for any a (follows from Definition 1). To establish that

S_{α}(\hat{R}₂, Ω₁)={q¹|q¹∈Ω₁, \hat{R}₂(q¹)=R₂(F₃(F₂(F₁(q¹))))≥α} is a convex set, we need to show that the inverse image of convex set S_{α}(R₂, Ω₄) under f₂=F₃∘F₂∘F₁ is convex (i.e., the inverse image of convex set S_{α}(R₂, Ω₄) under f₂ is S_{α}(\hat{R}₂, Ω₁)). Now F₁ and F₃ are linear-fractional functions, and from Property 1, we know that an inverse image of a convex set under F₁ and F₃ is a convex set. What remains is to show that the inverse image of a convex set under F₂ is a convex set.

Let D∈Ω₃ be a convex set. Its inverse image under F₂ is C={f₂⁻¹(y)|y∈d}. recall that f₂(x)=(a₁₂x₁^{b}^{₁₂}^{/b}^{₁₁}, . . . , aₙ₂xₙ^{b}^{ₙ₂}^{/b}^{ₙ₁}), and thus

$${F}_{2}^{- 1} ( y ) = ( {F}_{21}^{- 1} ( {y}_{1} ) , … , {F}_{2 n}^{- 1} ( {y}_{n} ) ) = ( {( \frac{{y}_{1}}{{A}_{12}} )}^{{b}_{11} / {b}_{12}} , … , {( \frac{{y}_{n}}{{A}_{n 2}} )}^{{b}_{n 1} / {b}_{n2}} ) .$$

Suppose that y⁽¹⁾ and y⁽²⁾ are in D. Then x⁽¹⁾=F₂⁻¹(y⁽¹⁾) and x⁽²⁾=F₂⁻¹(y⁽²⁾). Inverse image C is convex if and only if αx⁽¹⁾+(1−αx⁽²⁾)∈C for all α∈[0,1] and for all x⁽¹⁾ and x⁽²⁾ in C (i.e., x⁽¹⁾=F₂⁻¹(y⁽¹⁾) and x⁽²⁾=F₂⁻¹(y⁽²⁾) are in C because y⁽¹⁾ and y⁽²⁾ are in D). Because the elements of y are independent, if the above condition holds for the i^{th} element in x⁽¹⁾ and x⁽²⁾, then it holds for all elements, i.e., we need to check if αxᵢ⁽¹⁾+(1−α)xᵢ⁽²⁾)∈Cᵢ:={xᵢ|x∈C}. Note that

$$α {x}_{i}^{( 1 )} + ( 1 - α ) {x}_{i}^{( 2 )} = {α ( \frac{{y}_{i}^{( 1 )}}{{A}_{i 2}} )}^{{b}_{i 1} / {b}_{i 2}} + ( 1 - α ) {( \frac{{y}_{i}^{( 2 )}}{{A}_{i 2}} )}^{{b}_{i 1} / {b}_{i 2}}$$

and that

$${( \frac{{y}_{i}}{{A}_{i 2}} )}^{{b}_{i 1} / {b}_{i 2}}$$

is a strictly increasing function. Thus, there exists θᵢ∈[0, 1] that satisfies

$${α ( \frac{{y}_{i}^{( 1 )}}{{A}_{i 2}} )}^{{b}_{i 1} / {b}_{i 2}} + ( 1 - α ) {( \frac{{y}_{i}^{( 2 )}}{{A}_{i 2}} )}^{{b}_{i 1} / {b}_{i 2}} = {( \frac{{θ}_{i} {y}_{i}^{( 1 )} + ( 1 - {θ}_{i} ) {y}_{i}^{( 2 )}}{{A}_{i 2}} )}^{{b}_{i 1} / {b}_{i 2}} = {F}_{2 i}^{- 1} ( {θ}_{i} {y}_{i}^{( 1 )} + ( 1 - {θ}_{i} ) {y}_{i}^{( 2 )} ) .$$

Because D is convex, it is known that θᵢyᵢ⁽¹⁾+(1−θᵢ)yᵢ⁽²⁾∈Dᵢ:={yᵢ|y∈D}, which implies αxᵢ⁽¹⁾+(1−α)xᵢ⁽²⁾∈Cᵢ. Therefore, C is a convex set.

Let us summarize the implications of the above. We now know that inverse image of a convex set under F₁, under F₂, and under F₃ is a convex set. Therefore, beginning with convex set S_{α}(R₂, Ω₄), we obtain its convex inverse image under F₃. From this convex set, its convex inverse image is obtained under F₂, then repeat to obtain the convex inverse image under F₁. This process results in convex set S_{α}(\hat{R}₂, Ω₁), which proves that \hat{R}₂ is quasiconcave on Ω₁. Therefore \hat{R}ₖ is quasiconcave for any segment k.

### A.9 Proof of Proposition 5

Proof. It is first shown that the sequence generated by Algorithm 2 has at least one limit point. From equation (3), the optimal price pᵢ, i=1,2, . . . n must be bounded in the interval

$$[ {c}_{i} + \frac{1}{{max}_{k} {b}_{ik}} , {c}_{i} + \frac{1}{{min}_{k} {b}_{ik}} {max}_{k} {ρ}_{k} ] \qquad ( 16 )$$

where ρₖ is the optimal profit from a segment k customer if prices of all products are set to maximize segment k profit only. Specifically, ρₖ solves the single-variable equation (Li and Huh 2011, Theorem 2)

$${ρ}_{k} = {\sum }_{j = 1}^{n} \frac{{e}^{{a}_{jk} - {b}_{jk} {c}_{jk} - 1} {e}^{- {b}_{jk } {ρ}_{k}}}{{b}_{jk}}$$

and is finite. Thus the optimal price pᵢ, 1=1, 2, . . . , n must be finite. Hence we assume that one always starts with a finite price vector in Algorithm 2.

Note that given any bounded margin vector at the tth iteration,

$${\hat{p}}_{i}^{t + 1} = {\hat{p}}_{i}^{t} + {α}^{t} {d}_{i}^{t} = {\hat{p}}_{i}^{t} + {α}^{t} ( \frac{1}{{\sum }_{k = 1}^{m} ( \frac{{ω}_{k} {q}_{ik}}{{q}_{i}} ) {b}_{ik}} + {\sum }_{k = 1}^{m} ( \frac{{w}_{k} {b}_{ik} {q}_{ik}}{{\sum }_{l = 1}^{m} {w}_{l} {b}_{il} {q}_{il}} ) {r}_{k}^{t} - {\hat{p}}_{i}^{t} )$$

where

$${r}_{k}^{t} = {\sum }_{i = 1}^{n} {\hat{p}}_{i}^{t} {q}_{ik} ( {\hat{p}}^{t} ) .$$

Since α^{t}∈[0, 1], \hat{p}ᵢ^{t+1} is bounded in the interval [min (\hat{p}ᵢ^{t}, M^{t}), max (\hat{p}ᵢ^{t}, M^{t})] where where

$${M}^{t} = \frac{1}{{\sum }_{k = 1}^{m} ( \frac{{w}_{k} {q}_{ik}}{{q}_{i}} ) {b}_{ik}} + {\sum }_{k = 1}^{m} ( \frac{{w}_{k} {b}_{ik} {q}_{ik}}{{\sum }_{l = 1}^{m} {w}_{l} {b}_{il} {q}_{il}} ) {r}_{k}^{t} .$$

M^{t} is the sum of the multiplicative inverse of a weighted average of bᵢₖ values and a weighted average of the segment profits rₖ^{t}. Since rₖ^{t}≤ρₖ and ρₖ is finite, M^{t} is bounded by a finite constant

$$\frac{1}{{min}_{ik} {b}_{ik}} + {ρ}_{k} .$$

As a result,

$${\hat{p}}_{i}^{t + 1} \leq max \{ {\hat{p}}_{i}^{t} , \frac{1}{{min}_{ik} {b}_{ik}} + {ρ}_{k} \} .$$

Hence, the sequence {\hat{p}^{t}} is bounded and consequently has at least one limit point (see Bertsekas 2003, Proposition A.5, p. 666). Furthermore,

$$∇ {h ( {\hat{p}}^{t} )}^{T} {d}^{t} = - {\sum }_{i = 1}^{n} {\sum }_{k = 1}^{m} {w}_{k} {b}_{ik} {{q}_{ik} ( {p}_{i}^{t} - {\sum }_{k = 1}^{m} ( \frac{{w}_{k} {b}_{ik} {q}_{ik}}{{\sum }_{l = 1}^{m} {w}_{l} {b}_{il} {q}_{il}} ) {r}_{k}^{t} - \frac{1}{{\sum }_{k = 1}^{m} ( \frac{{w}_{k} {q}_{ik}}{{q}_{i}} ) {b}_{ik}} )}^{2} < 0$$

unless \hat{p}^{t} is already a stationary point. Hence, {d^{t}} is gradient-related to {\hat{p}^{t}} and every limit point of the sequence {\hat{p}^{t}} is a stationary point of h (See Bertsekas 2003, Proposition 1.2.1, p. 43).

### A.10 Proof of Proposition 6

Proof. The proof follows the same argument as in the proof of Proposition 5 and is omitted here.

### A.11 Data Fitting Details

In the following, we provide the details of data fitting and testing as provided. Because not all product attributes are relevant for all customer segments, Corporation A suggested that segment-specific subset of regressors should be used to prevent problems stemming from over-fitting or oversimplifying. To that end, a variety of models were tested for each segment where a model refers to a particular subset of the regressors.

The first three generations of products (13 SKUs) were used to parameterize the demand model and the fourth generation of products (3 SKUs) to test the model, mimicking the practical context at Intel. For any given customer segment, the market share prediction is computed for each product; the model was selected using the mean absolute error (MAE) for the market share of each product.

Table 6 presents a summary of goodness-of-fit and test measures for the selected model for each segment including the Estrella index (which is a value between 0 and 1, larger number corresponding to a better fit), the training MAE, and the test MAE. The model for each segment is chosen by focusing primarily on the test MAE and secondly on the training MAE, and by balancing model parsimony and the test errors.

TABLE 6
Fit and Forecast Accuracy.

| | | Estrella | Taining | Test |
|---|---|---|---|---|
| Segment | Chosen Model | Index | MAE | MAE |
| 1 | TDP, Performance, | 89% | 10% | 17% |
| | Price/performance | | | |
| 2 | Frequency, TDP, Price, | 62% | 13% | 1% |
| | Price/performance | | | |
| 3 | Performance, Price/ | 78% | 12% | 2% |
| | performance | | | |
| 4 | Performance, Price/ | 53% | 13% | 9% |
| | performance | | | |
| 5 | Frequency, Price, | 71% | 10% | 6% |
| | Price/performance | | | |
| 6 | Performance, Price/ | 50% | 14% | 10% |
| | performance | | | |
| 7 | Performance, Price/ | 54% | 13% | 13% |
| | performance | | | |

The coefficients and the corresponding standard errors (in parenthesis) of the selected regression model for each segment are given in Table 7.

TABLE 7
Linear Utility Coefficients for Each Customer Segment.

| Seg- | | | | | Price/ |
|---|---|---|---|---|---|
| ment | Frequency | TDP | Performance | Price | performance |
| 1 | — | −0.2791 | 0.02885 | — | −0.786 |
| | | (0.0095) | (0.00066) | | (0.170) |
| 2 | 2.007 | −0.0244 | — | 0.00105 | −3.677 |
| | (0.162) | (0.0086) | | (0.00051) | (0.131) |
| 3 | — | — | 0.00936 | — | −0.993 |
| | | | (0.00031) | | (0.106) |
| 4 | — | — | 0.00267 | — | −2.201 |
| | | | (0.00027) | | (0.099) |
| 5 | 2.512 | — | — | 0.00490 | −2.846 |
| | (0.135) | | | (0.00032) | (0.109) |
| 6 | — | — | 0.00729 | — | −0.615 |
| | | | (0.00030) | | (0.084) |
| 7 | — | — | 0.00777 | — | −0.625 |
| | | | (0.00030) | | (0.087) |

### A.12 Segment-Specific Sales Distribution Among Products

Table 8: Sales Distribution under Current Practice (Each Number Represents Segment-specific Choice Probability for the Corresponding Product).

TABLE 8

| | Segment | | | | | | |
|---|---|---|---|---|---|---|---|
| Product | S1 | S2 | S3 | S4 | S5 | S6 | S7 |
| 1 | 0.0008 | 0.0982 | 0.0464 | 0.1505 | 0.0451 | 0.0726 | 0.0661 |
| 2 | 0.0044 | 0.3359 | 0.0764 | 0.1457 | 0.3169 | 0.1087 | 0.1018 |
| 3 | 0.9897 | 0.3938 | 0.5274 | 0.4003 | 0.3954 | 0.4716 | 0.4829 |

Table 9: Sales Distribution under Profit-improving Solution (Each Number Represents Segment-specific Choice Probability for the Corresponding Product).

TABLE 9

| | Segment | | | | | | |
|---|---|---|---|---|---|---|---|
| Product | S1 | S2 | S3 | S4 | S5 | S6 | S7 |
| 1 | 0.0017 | 0.2063 | 0.0862 | 0.3339 | 0.0848 | 0.1043 | 0.0962 |
| 2 | 0.0097 | 0.6924 | 0.1425 | 0.3256 | 0.5198 | 0.1565 | 0.1486 |
| 3 | 0.9807 | 0.0282 | 0.3590 | 0.0957 | 0.2065 | 0.3634 | 0.3736 |

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method, comprising:
configuring a computing device with instructions for executing operations comprising:
defining a discrete choice model utilizing customer segment information;
solving the discrete choice model to generate an optimal price based on a profit function utilizing the customer segment information by:
identifying a number of products from the customer segment information;
determining a concavity value of the profit function from a set of predefined parameters, the set of predefined parameters defined by the customer segment information; and
generating, based upon the concavity value of the profit function, at least two scenarios, wherein
the scenarios generate the optimal price based on an analysis of the customer segment information.

2. The method of claim 1, wherein a scenario of the at least two scenarios is generated for a profit function defining a concavity value that is quasiconcave.

3. The scenario of claim 2, wherein the computing device is configured to utilize a bisection search algorithm with the scenario to generate the optimal price for the profit function having a concavity value that is quasiconcave.

4. The method of claim 1, wherein a scenario of the at least two scenarios is generated for a profit function defining a concavity value that is not quasiconcave.

5. The method of claim 4, wherein the computing device is configured to utilize a gradient descent procedure to generate the optimal price for the profit function defining a concavity value that is quasiconcave.

6. The method of claim 1, wherein the discrete choice model aligns with the setting of a market that can be decomposed into a finite number of market segments.

7. The method of claim 1, wherein the customer segment information includes a performance measure, a cache, a measure of price, and a measure of price with respect to performance.

8. A method, comprising:
configuring a computing device with instructions for executing operations comprising:
defining a discrete choice model utilizing customer segment information;
solving the discrete choice model to generate an optimal price based on a profit function utilizing the customer segment information by:
identifying a number of products from the customer segment information;
determining a concavity value of a profit function from a set of predefined parameters, the set of predefined parameters defined by the customer segment information;
obtaining, based on the concavity value of the profit function, an initial interval containing an optimum solution;
solving a feasability problem across the initial interval using the customer segment information; and
computing, based on the solution of the feasability problem, a price for optimally pricing the number of products across a customer segment.

9. The method of claim 8, wherein the pricing data is applied to business-to-business durable goods

10. The method of claim 8, wherein the discrete choice model includes a discrete mixed multinomial logit model defining coefficients varying by customer.

11. The method of claim 8, wherein the discrete choice model maintains the same product prices across customer segments.

12. The method of claim 8, wherein if the profit function is not quasiconcave a gradient descent procedure is used to obtain a price vector that is a stationary point of the profit function.

13. The method of claim 8, wherein a customer is categorized based on historical purchasing volumes.

14. The method of claim 8, wherein a multinomial discrete choice procedure is used to obtain customer segment specific coefficients.

15. The method of claim 8, wherein a segment specific no-purchase option is determined by computing segment-specific utilities of retired products using the customer segment specific coefficients.

16. The method of claim 8, wherein the concavity value of the profit function is quasiconcave.

17. A method, comprising:
configuring a computing device with instructions for executing operations comprising:
defining a discrete choice model utilizing customer segment information;
solving the discrete choice model to generate an optimal price based on a profit function utilizing the customer segment information by:
identifying a number of products from the customer segment information;
determining a concavity value of a profit function from a set of predefined parameters, the set of predefined parameters defined by the customer segment information; and
computing, based on the concavity of the profit function and using the customer segment information, a price vector by using a gradient descent procedure, wherein the price vector represents the optimal price.

18. The method of claim 17, wherein the profit function is not quasiconcave.

19. The method of claim 17, wherein a customer is categorized based on historical purchasing volumes.

20. The method of claim 17, wherein a multinomial discrete choice procedure is used to obtain customer segment specific coefficients.

21. The method of claim 17, wherein a segment specific no-purchase option is determined by computing segment-specific utilities of retired products using the customer segment specific coefficients.

22. The method of claim 17, wherein the price vector is a stationary point of the profit function.

23. The method of claim 17, wherein additional stationary points used to compare a set of profits to identify a best profit are obtained by randomly generating starting price vectors based on the predefined parameters.
